(19) United States
(12) Patent Application Publication
(10) Pub. No.: US 2014/0249875 A1
(43) Pub. Date: Sep. 4, 2014

(54) DETECTING CASES WITH CONFLICTING RULES

(71) Applicant: INTERNATIONAL BUSINESS MACHINES CORPORATION, ARMONK, NY (US)

(72) Inventors: Ulrich M. Junker, Biot (FR); Olivier M. D. Lhomme, Cagnes Sur Mer (FR)

(73) Assignee: INTERNATIONAL BUSINESS MACHINES CORPORATION, ARMONK, NY (US)

(21) Appl. No.: 14/349,951

(22) PCT Filed: Dec. 5, 2012
(86) PCT No.: PCT/IB2012/056970

§ 371 Date: Apr. 4, 2014

(30) Foreign Application Priority Data
Dec. 21, 2011 (EP) 11306726.8

(51) Int. Cl. G06Q 10/06

(52) U.S. Cl. CPC G06Q 10/063
USPC 705/7.11

(57) ABSTRACT

A method, system and/or computer program product for managing condition action rules comprises: a treated case modeler for building a family of cases that make some rules applicable; a conflict detector for iteratively building and testing subsets of cases of the family searching for cases with conflicting decisions in order to locate a subset of cases that all have conflicting decisions. The conflict detector is further adapted for eliminating subsets of cases that have all non-conflicting decisions. The conflict detector is further adapted for distinguishing conflicting decisions from unrelated decisions and thus avoids the reporting of false conflicts.

### BACKGROUND

The present invention generally relates to a rule management system and specifically to a method and apparatus for computing cases with conflicting rules in a rule management system.

Business Rule Management (BRM) technology relates to the area of decision-making automation in business problems such as loan approval, insurance claim processing or customer loyalty programs. A Business Rule Management System (BRMS) is implemented to work with rule projects. A BRMS allows rule editing in a controlled natural-like language, which makes it easy to use without specific knowledge on generating rules. The rules can be kept in different versions in a rule repository. A BRMS further allows the execution of the rules by a rule engine, which also performs a rule analysis for detecting conflicting rules, redundant rules, and missing rules. Another feature is rule validation by test and simulation.

Business rules are a convenient way to represent decision making policies for making decisions depending on given cases. A case usually consists of a combination of features and a decision may be a combination of elementary choices. A business rule makes a decision by applying an action to a given case. A business rule cannot handle all cases, but only those that satisfy a condition. A business rule thus consists of a condition, which usually is a combination of tests, and an action, which may consist of a sequence of elementary steps. As a business rule treats only certain cases, it defines only a part of the whole decision making process. Further business rules are needed to make a decision for the remaining cases. If the given business rules are making a decision for each relevant case, then such a collection of rules is complete. Otherwise, the rules will not treat every case and further rules need to be added to make the rules complete.

Decision automation for problems such as insurance claim processing, loan approval, or discount calculation for shopping carts consists in making decisions for a huge number of cases in a consistent and predictable way. Decision automation is achieved through business policies comprising business rules, which map each possible case to a single decision. Business rules provide a convenient way to represent complex policies which make decisions for diverse and complex forms of cases. Each rule represents an independent part of the policy and makes a decision for a subset of the cases. A business rule consists of a condition describing the cases treated by the rule and an action that consists of making the decision for a case. As cases may be complex and consist of different objects (such as the different items in a shopping cart), a business rule may treat only selected objects of the case and thus has a scope describing the kinds of objects it may treat. A complex policy can thus be represented by a set of business rules in a simple way.

As there are numerous ways to represent a policy in terms of rules, additional criteria are necessary to determine good representations for decision automation. Firstly, it is important to keep the representation manageable and as small as possible. The number of rules can be reduced by making the rules as general as possible and by avoiding redundant rules. Secondly, different rules should be independent of each other in order to facilitate modification of rules due to a change of a business policy. If the business policy is changing for some case, then the business user needs to adapt all rules treating this case to the new policy. If the rules are overlapping, then a policy change may require a modification of several rules. This overhead in rule editing is acceptable if the overlaps are due to the fact that the rules are as general as possible. However, it is not acceptable if there are redundant rules that can be removed without changing the decision-making behavior of a rule set.

A decision policy defines which decision will be made for which case. A decision policy makes the same decision for all cases that have the same characteristics and thus guarantees a basic form of consistency of the decision making process. This is important for problems such as insurance claim processing, loan approval, or discount determination which all involve the treatment of a large number of cases on a routine basis. Several of these cases may have the same characteristics and a comparison of the decisions of those cases may, in principle, be possible. A consistent treatment of those cases is thus important for achieving a predictable behavior, for automating the decision making process, and for satisfying the customer base.

The cases of a decision-making problem are usually characterized by multiple objects having multiple attributes, meaning that the decision policy is a mapping from a multi-dimensional case space to the set of decisions. If such a complex policy consists of different parts which depend only on some attributes, but not on all, then each part can be represented by a production rule (or condition-action rule). A production rule consists of a condition describing the cases treated by the rule and an action which consists of making the decision for a case. Furthermore, a rule has a scope defining which objects of the case are inspected (or matched) by the rule. Whereas a case may consist of an unbounded number of objects (such as the different items in a shopping cart), a rule will treat only a fixed number of objects of the case.

A set of rules thus provides a convenient way to represent a decision policy for complex cases. Whereas each decision policy can be represented by some ruleset, not every ruleset represents a valid decision policy. In particular, there may be rules that are making different decisions for the same case and these decisions may be in conflict. For example, a rule accepting a loan conflicts with a rule rejecting a loan if there is some case that is treated by both rules. The decisions of those rules are in conflict, as it is not both possible to accept and reject the same loan request. This means, things cannot be arranged in a way such that both decisions are effective for the case.

Whereas problems such as loan approval consists of making a single decision, other problems such as insurance claim processing may involve multiple decisions, namely the acceptance or rejection of the insurance claim and the determination of the amount of damage. A rule that accepts an insurance claim and a rule that determines an amount of damage are making different decisions, but these decisions are not in conflict. It is possible to arrange things in a way such that both decisions are effective. Indeed, both decisions are independent of each other and concern different aspects of the overall problem. This is not true for a rule that accepts an insurance claim and a rule that rejects the same insurance claim. Those rules have conflicting decisions.

This discussion shows that additional knowledge is needed to determine whether different decisions are conflicting or not if the rules make multiple decisions. There are different ways to provide knowledge about conflicting decisions. The knowledge may be given in an implicit form by an adequate structuring of the rule-set or an adequate representation of the rule action. In a well-structured rule set, rules are packed into different groups such that the rules of a group concern a single decision. The rules of a group thus make alternative choices for the same decision and two rules of a group are in conflict if they make different decisions for the same case. However, in general such a well-disciplined structuring is not given. If the rule actions are represented in form of assignments of values to attributes of objects, two rules have conflicting decisions if and only if they assign different values to the same attribute of the same object. Hence, the form of the actions enables a detection of conflicts. This is no longer possible for more general and abstract forms of actions which may just be described by some method that is applied to some arguments. As those methods constitute abstract behavior descriptions, explicit knowledge is needed to declare which methods are making conflicting decisions.

A general system for analyzing the consistency of a ruleset must thus be able to deal with rules making multiple decisions that are made by arbitrary forms of actions whether they are represented by concrete assignments or by abstract method invocations. Such a system must distinguish rules that are making conflicting decisions from rules that are making different, but unrelated decisions. For this purpose, the rule analyzer needs to take conflicting actions into account. Furthermore, a rule author does not necessarily need to know which rules are in conflict, but has to find out the cases for which these conflicts arise. A consistency analyzer must thus be able to characterize and report the cases with conflicting rules. The description of those cases provides crucial information that allows the rule author to modify the rule set in order to ensure a consistent decision making. For example, the rule author may add a rule of higher priority that plays the role of an arbitrator and that imposes the preferred decision for those cases, while leaving the existing rules unchanged.

Existing systems and methods for detecting conflicting rules are limited in one or the other aspect. Classic methods limit consistency analysis to decision tables which represent a group of rules making alternative choices for the same kinds of decision. For examples, various and different known prior art report a conflict between two rules if the rules have overlapping conditions, but differ in their actions. As the decision tables completely describe the rule actions, two rules have conflicting actions as soon as the rules have different table entries in some action column (or action row depending on the orientation of the table). It is important to understand that these methods are unable to find conflicts among the rules belonging to different tables for the reasons described above. Furthermore, those methods cannot find conflicts between rules of arbitrary form.

The method described in the article ‘An Approach to Verifying Completeness and Consistency in a Rule-Based Expert System’ by Motoi Suwa, A. Carlisle Scott and Edward H. Shortliffe assumes that each rule is making a single decision which has an adequate form, namely that of assigning a value to the object matched by the rule. The method then groups rules according to the scope of the rule, i.e. the type of the matched object, and the attribute that is assigned by the rule. For each of the groups, the method builds a decision table that represents the rules of the group and then seeks rows with overlapping conditions and different actions. As the method supposes that rule actions have the form of assignments, it cannot find conflicts among rule actions that have the form of abstract method calls.

Similar restrictions hold for methods that detect conflicts between rules that assign different values to the same attribute or parameter. Examples are the conflict checker in known prior art, including the consistency analyzer of IBM WebSphere Ilog JRules BRMS 7.1. Those methods use constraint satisfaction techniques to check whether there is a case that satisfies the conditions of two rules that have conflicting assignments. Although those analyzers are able to find conflicts among rules that have arbitrary conditions, they suppose that the rule actions have the form of assignments. As they do not take knowledge about conflicting actions into account, they do not find a conflict between a rule that accepts a loan by invoking a method ‘accept’ for a loan object and a rule that rejects a loan by invoking a method ‘reject’ for the same loan object.

Other known prior art simply states that two rules are in conflict if they have overlapping (or matching) conditions and different actions. Those methods cannot distinguish conflicting rules from rules making unrelated, but non-conflicting decisions. A similar remark holds for non-confluence analysis as it is known for term-rewriting systems. Non-confluence analysis may be adapted to production rules to find different sequences of rules that lead from the same initial state to different final states. However, as argued above a difference of two final states does not necessarily mean that conflicting decisions have been made by the two rule sequences. In a multiple-decisions problem, it is possible that not all decisions have been made in each sequence. Hence, the final states may be different since some decisions is missing in one of them. A non-confluence thus indicates that there are either cases with conflicting decisions or executions with missing decisions. The non-confluence analysis alone is thus insufficient for detecting cases with conflicting decisions.

Conflict detection methods for logical rules and default rules use knowledge about conflicting conclusions (such as the mutual exclusion constraints in known prior art, including the modality conflicts in the article ‘Expressive policy analysis with enhanced system dynamicity’ by Craven et al.). Whereas the usage of such constraints is natural in a logical rule system, their usage for conflict analysis for condition-action rules leads to additional difficulties that are not addressed by these previous works. In a logical framework, it is easy to accumulate the conclusions of multiple rules in a single state and to post constraints on them. In order to achieve similar capabilities for condition-action rules, adequate logical representations of the rule actions need to be elaborated.

This examination of existing approaches thus demonstrates that there is no method and system that finds conflicts among rules having arbitrary forms of conditions and actions. Moreover, existing methods for detecting conflicting rules assume that the conflict is resolved by modifying one or both of two conflicting rules. As such, they focus on the problem on detecting conflicts among rules.

An example of the problem is described. Analyst Alan at Fair Credits Inc. writes a rule that accepts a loan if the loan amount is at most $600 k and the debt rate is at most 35%. Reviewer Ryan at Fair Credits writes a rule that rejects a loan if the amount is more than $300 k and the debt rate is more than 30%. Customer Jim gets his request for $500 k at a debt rate of 32% accepted. Customer Jane gets her request for $500 k at a debt rate of 32% rejected. Journalist Mary and friend of Jim and Jane publish an article about unfair customer treatment at Fair Credits. Fair Credits looses 20% at the stock market.

Fair Credits managers ask Business Rules Management System (BRMS) administrator Bob to report all cases with conflicting decisions. Bob does not find the reporting feature in the BRMS tool and even the conflicting rules analysis does not report the problem. Bob concludes that the BRMS tool has serious limits.

None of these references shows how to compute families of cases with conflicting decisions.

### SUMMARY

A method, system and/or computer program product for managing condition action rules comprises: a treated case modeler for building a family of cases that make some rules applicable; a conflict detector for iteratively building and testing subsets of cases of the family searching for cases with conflicting decisions in order to locate a subset of cases that all have conflicting decisions. The conflict detector is further adapted for eliminating subsets of cases that have all non-conflicting decisions. The conflict detector is further adapted for distinguishing conflicting decisions from unrelated decisions and thus avoids the reporting of false conflicts.

### BRIEF DESCRIPTION OF SEVERAL VIEWS OF THE DRAWINGS

Embodiments of the invention will now be described, by means of example only, with reference to the accompanying drawings in which:

FIG. 1 is a table providing an example for rules that make conflicting decisions for certain cases;

FIG. 2 is a state diagram depicting rules in two-dimensional case space with a loan amount axis and a debt rate axis;

FIG. 3 is a component diagram of the preferred embodiment;

FIG. 4 is a component diagram of the rules management system of the preferred embodiment;

FIG. 5 is a ruleset applicability graph for describing the cases treated by the ruleset in a compact logical form;

FIG. 6 is a ruleset implication graph for describing that the actions of the applicable rules will be executed by the ruleset;

FIG. 7 is a component diagram of conflict detector including interactions between the components;

FIG. 8 is an overview flow chart of execution trace steps of the conflict detector for the ruleset given in FIG. 1;

FIG. 9 to FIG. 14 show each trace step of FIG. 8 in more detail;

FIG. 15 is a component diagram of treated-case generator;

FIG. 16 is an example of a quantifier-free rules instances applicability graph 154;

FIG. 17 is solved rule instances applicability graph 158 for the example of FIG. 16;

FIG. 18 is a component diagram of a conflict checker including interaction flow;

FIG. 19 is a solved non-conflict graph for the example of FIG. 10;

FIG. 20, is a non-conflict graph for the example of FIG. 12; and

FIG. 21 is a non-conflict graph for the example of FIG. 14.

### DETAILED DESCRIPTION

Rules are a convenient way to express that certain decisions, such as accepting or rejecting a loan request, are made for a whole set of cases and not just for a single case. In particular, they permit the decision maker to generalize decisions made for particular cases by extending those decisions to a family of similar cases. For example, the decision to accept a request of a loan of $200,000 for a debt rate of 35% may be generalized to loan requests up to $600,000 and up to a debt rate of 35%. The result of this generalization step is a rule that accepts a loan request if its amount is at most $600,000 and if its debt rate is at most 35%. Independent of this, the decision to reject a loan of $300,000 for a debt rate of more than 40% may be generalized to loans requesting more than $300,000 and a debt rate of more than 30%. The result of this second generalization step is a rule that rejects a loan request if its amount is more than $300,000 and it its debt rate is more than 30%. When applying those rules to a loan request of $500,000 and a debt rate of 32%, the loan will be both rejected and accepted. Hence, the decision making behavior of these rules is inconsistent as it is not possible to arrange things in a way such that a loan is both rejected and accepted. These decisions are in conflict and only one of them should be chosen.

Cases with conflicting decisions can arise for several reasons. First of all, they may be introduced when generalizing decisions for existing cases. The generalization steps may be carried out independently from each other and follow their own rationales (such as find rules with most-general conditions that generalize the decision for an existing case). Furthermore, cases with conflicting decisions can be introduced when changing the existing rules as the modification of rules may introduce overlaps with other rules. The inconsistencies are obtained due to unforeseen interactions between rules and not only arise in the context of collaborative rule authoring, but also if the rules are defined by a single rule maker. Indeed, the nature of the rules make inconsistencies almost inevitable. Rules constitute compact and simple representations of complex decision policies. The rules represent the different pieces of the decision policy independently from each other. More general rules are preferred to more specific rules as more general rules lead to shorter and simpler descriptions of the rule conditions and also reduce the overall number of rules. However, a high degree of generality of rule conditions easily leads to overlaps between rule conditions and to inconsistencies if those overlapping rules make conflicting decisions. Hence, the problem stems from the fact that the whole area in case space needs to be covered by blocks of cases that can be treated by a single rule.

A classic approach to resolve conflicts between rules consists in modifying the condition of one or both rules such that the conditions no longer overlap.

The classic approach has several draw-backs. Firstly, it requires identification of all rules that make conflicting decisions for a case. Indeed, it is possible that more than two rules make conflicting decisions for each case. Secondly, it requires a modification of the rules in order to ensure that they no longer overlap.

A simple approach is to declare one of the rules as winner and to give it a higher priority than the other rules.

A further approach consists in modifying the rule conditions in order to avoid any overlap. This modification may lead to more complex descriptions of rule conditions involving a nesting of conjunctions and disjunctions.

In an alternative approach, a rule can be split up into several more specialized rules. All these methods require a tedious investigation of the existing rules.

However, the approach adopted by the embodiment is to directly address the cases that have conflicting decisions. Instead of repairing the existing rules, the rule maker may add a rule of higher priority that makes the right decision for these cases and that serves as arbitrator. A single arbitrator rule may make a decision for a whole family of similar cases having conflicting decisions. If defined adequately, the arbitrator rules have the same form as the other rules. The embodiment approach preserves the simplicity and generality of rules while treating inconsistencies by adding a layer of arbitrator rules. The embodiment approach no longer requires the identification of the conflicting rules. It simply requires the detection of a family of cases with conflicting decisions.

It might be argued that conflicts between rules need not be resolved as the rule engine will execute conflicting rules in some order. Indeed, if several rules are in conflict, only the decision of one of the rules will be effective and it is not possible to encounter a situation where, for example, a loan is both accepted and rejected. Due to this, conflicting decisions may not show up when a rule engine applies the rules to a single case. However, conflicts may be revealed when the engine is invoked multiple times for similar cases. If there are conflicting rules, the decision made in the end will depend on the order in which the engine executes the rules. This order may depend on secondary criteria (such as names of objects, internal memory addresses and so on) which may vary for equivalent cases and for different invocations of the engine. As a consequence, the engine may make different decisions for equivalent cases when invoked multiple times. Hence, the rule-based system produces different outputs for the same input when invoked multiple times. Conflicting rules can thus cause an erratic behavior of the rule engine and it should be possible to observe this behavior within a larger sampling of engine runs.

However, conflicting rules are not the only reason for erratic behavior. A rule-based system may also produce different outputs for the same input if the order of multiple rules is important to making the decision. For example, the rule set for insurance claim processing has to decide whether the claim is accepted or rejected using a sequence of rules including determining the amount of damage. If a rule engine is applied multiple times to equivalent insurance claims, it may execute the rules in a different order. So in this example, the rule engine will produce different outputs for the same input.

Missing decisions are another reason for obtaining different outputs. As a ruleset can make multiple decisions, it is not sufficient to compare the resulting output states when seeking cases with conflicting decisions. Different output states are due to an issue of 1) conflicting decisions; or 2) missing decisions. A deeper analysis is thus necessary to distinguish these two issues.

A conflicting-rules analyzer therefore has to distinguish rule actions that make conflicting decisions (such as accept and reject the same insurance claim) from rule actions that make unrelated decisions (such as accept an insurance claim and determine its amount of damage). In order to distinguish conflicting and unrelated decisions, the analyzer needs additional knowledge about rule actions. For example, the analyzer needs to know that the actions of accepting and rejecting the same insurance claim are incompatible as they make conflicting decisions.

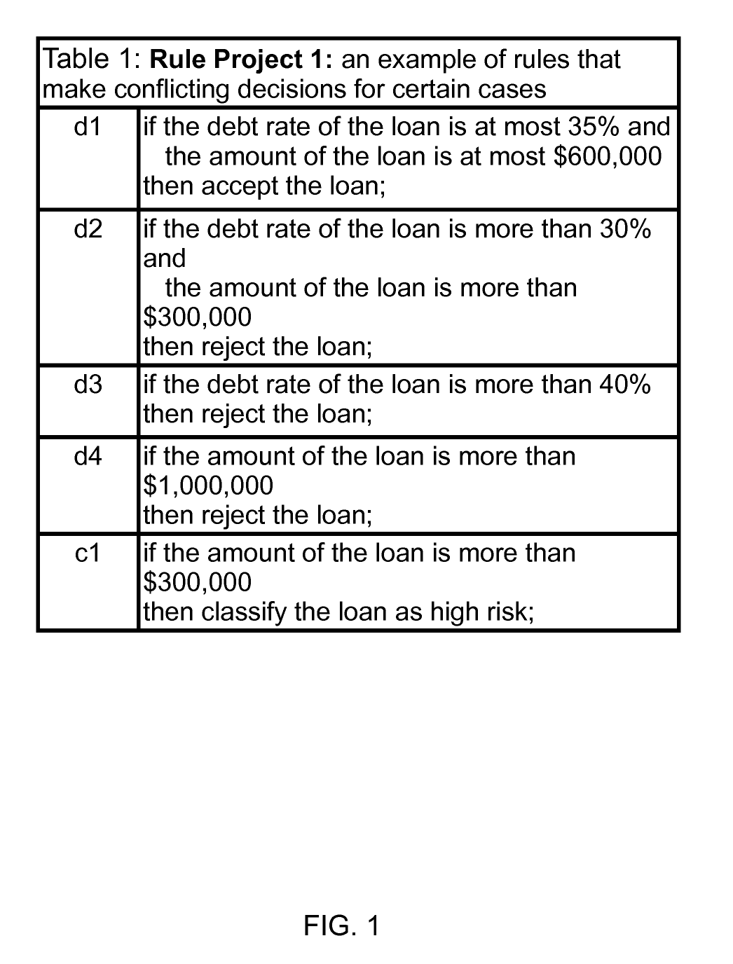

With reference now to the figures, FIG. 1 is a table (Table 1: Rule Project 1) providing an example for rules that make conflicting decisions for certain cases. In one embodiment, the rules are written in Business Action Language (BAL) of IBM WebSphere Ilog JRules BRMS 7.1. The rules make a decision about acceptance or rejection of a loan request depending on the amount of the loan request and its debt rate. The rules may also classify the loan request into categories such as low risk or high risk. For example, rule d1 accepts a loan if its debt rate is at most 35% and its amount is at most $600 k:

rule d1:
set Loan1 to a loan;
if the debt rate of Loan1 at most 35% and
   the amount of Loan1 at most $600,000
then accept Loan1;

Rule d2 rejects a loan request if its debt rate is more than 30% and its amount is more than $300 k:

rule d2:
set Loan1 to a loan;
if the debt rate of Loan1 is more than 30% and
   the amount of Loan1 is more than $300,000
then reject Loan1;

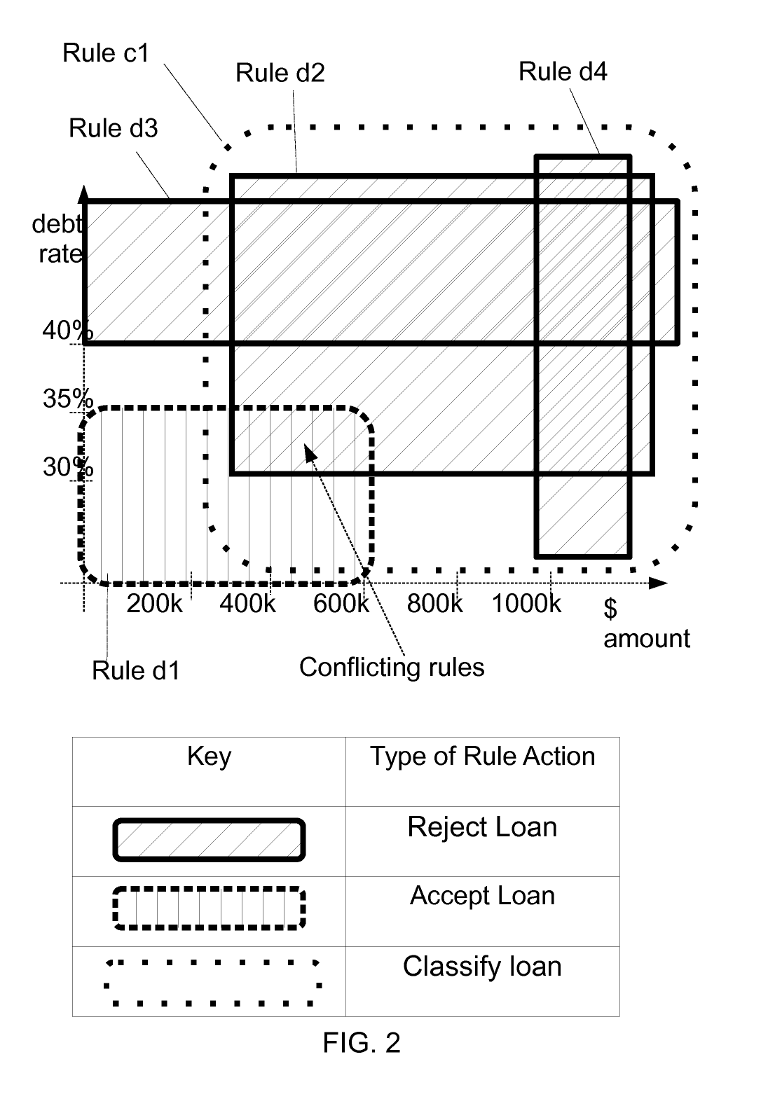

These rules will both accept and reject a loan request that has, for example a debt rate of 35% and an amount of $600 k. Hence, the conflicting rules are making conflicting decisions for those cases as shown in the marked cross hatched shaded area of FIG. 2.

Rules d3 and d4 reject a loan if its amount is more than $1000 k or its debt rate is more than 40%:

rule d3:
set Loan1 to a loan;
if the debt rate of Loan1 is more than 40%
then reject Loan1;

rule d4:
set Loan1 to a loan;
if the amount of Loan1 is more than $1,000,000
then reject Loan1;

Finally, rule c1 assigns a high risk to a loan if its amount exceeds $300 k:

rule c1:
set Loan1 to a loan;
if the amount of Loan1 is more than $300,000
then classify Loan1 as high risk;

A loan request of $2000 k and a debt rate of 50% will make several rules applicable, namely d2, d3, d4, and c1. As the rules d2, d3, d4 all reject this loan request, they are not in conflict. Furthermore, rule c1 classifies a loan as high risk independently of the decision of accepting or rejecting this loan. Hence, classifying a loan as high risk is compatible with rejecting this loan. Hence, the given loan request leads to multiple decisions that are different, but not conflicting.

FIG. 2 is a state diagram depicting case space as a two-dimensional coordinate system with a loan amount axis and a debt rate axis. FIG. 2 shows decision-making behavior of the ruleset for a single loan. The cases treated by the rules correspond to rectangular blocks. Different forms of hatching represent the acceptance or rejection of a loan. Cases with conflicting decisions are obtained in the space where different forms of rules (marked by different hatching) overlap.

In an object-oriented rule language such as that of IBM WebSphere Ilog JRules BRMS 7.1, the rule actions can be represented in an abstract form in terms of method invocations. For example, a class declaration of a loan has three methods representing the three actions of loan acceptance (void accept ( )), loan rejection void reject( )), and loan classification (void classify ( . . . )) where the term ‘void’ defines a method:

class Loan {
void accept( );
void reject( );
void classify(RiskCategory risk);

}

This example loan class declaration defines the argument and return types of the methods, but does not exhibit any information about the role they play. The class declaration does not explain that the method invocations x.accept( ) and x.reject( ) constitute the options of the approval decision for loan x. Furthermore, the class declaration does not explain that the method invocations x.classify(y) for the different risk categories y constitute the options of the classification decision for loan x. Hence, an additional definition of the decisions is needed to understand the role of the class methods for the decision-making process.

The present embodiments use such a definition of the decisions in order to detect actions that make conflicting decisions. As the different options for a decision are mutually exclusive, the analyzer can derive that the method invocations x.accept( ) and x.reject( ), which represent the actions ‘accept x’ and ‘reject x’ are incompatible. Furthermore, it can conclude that the method invocations x.classify(y) and x.classify(z) are incompatible if the risks y and z are different.

An explicit definition of decisions is usual in decision support systems and constitutes a convenient way to provide knowledge about conflicting decisions. Such definitions of decisions need to take the particularities of rule-based decision making into account, which is to make decisions of multiple kinds for multiple objects. In addition to a list of options, the definition of a decision of a ruleset thus has to take the scope of the decision into account, that is, the number and types of objects for which it is made. For example, a loan approval decision is made for a loan object. Hence, the scope of this decision is that of a loan object. The options of the decision are then actions that are applied to the objects of the scope. For example, a loan approval decision for an object Loan1 of type loan has the options of accepting the object Loan1 or of rejecting this object. A possible syntax for this decision definition consists of the keyword ‘decision’ followed by the name of the decision and a scope declaration as well as an option description. The scope declaration may have the same syntax as the scope declaration of a rule, that is, a list of object declarations such as ‘set Loan1 to a Loan’. The option description uses the phrase ‘the options are to <action1>, to <action2>, . . . , and to <action n>’. The actions have the same syntax as rule actions. The loan approval decision can thus be defined as follows:

decision LoanApproval
set Loan1 to a loan;
the options are to accept Loan1 and to reject Loan1;

Other decisions may have to make a choice between different applications of the same action. In this case, the action is applied to additional arguments and the options differ in the values of those arguments. For example, the loan classification decision consists in classifying the loan object as a risk where the risk is a low risk or a high risk. The option description of such a decision therefore declares these arguments, their types, and possibly their domains. For example, the loan classification decision can be defined as follows:

decision Loan Classification
set Loan1 to a loan;
the options are to classify Loan1 as Risk1
where Risk1 is a risk category in {low risk, high risk};

If decision definitions are available, then a conflicting-rule analyzer can extract knowledge about incompatible actions from them. For example, it may derive that it is not possible to both accept and reject a loan. However, if decision definitions are not available those incompatibility constraints need to be specified explicitly. Again, they have a scope describing the objects that are subject of the constraint. Furthermore, they list a set of actions that are all mutually incompatible. A possible syntax for such an incompatibility constraint starts with the keyword ‘constraint’ followed by the scope declaration and an incompatibility description. The incompatibility description uses the phrase ‘it is mutually incompatible to <action1>, to <action2>, . . . , and to <action n>’. For example, the incompatibility of accepting and rejecting the same loan can be expressed as follows:

constraint:
set Loan1 to a loan;
it is mutually incompatible to accept Loan1 and to reject Loan1;

If more than two actions are listed, then these actions are all mutually incompatible. The incompatibility constraints express binary conflicts between decisions.

Incompatibilities can also arise if the same action is applied to different arguments. Those incompatibility constraints have to declare those arguments as part of their scope. Furthermore, they include a condition part stating that the arguments are different. For example, the incompatibility of classifying a loan in two different ways can be stated as follows:

constraint:
set Loan1 to a loan;
set Risk1 to a risk category;
set Risk2 to a risk category;
if Risk1 does not equal Risk2
then it is mutually incompatible to classify Loan1 as Risk1 and to classify Loan1 as Risk2;

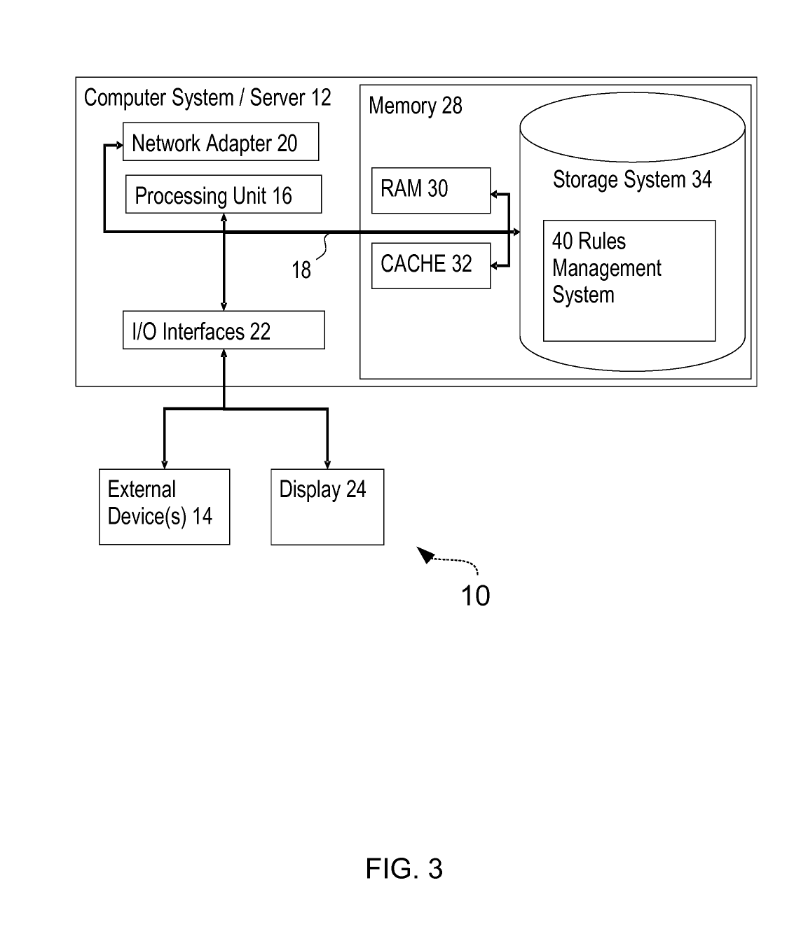

Referring to FIG. 3, there is shown a deployment diagram of a computer system node 10 for a rule management system of the preferred embodiment. Computer system node 10 comprises a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be embodied in distributed cloud computing environments where tasks are performed by remote processing devices that are linked through a communications network. In a distributed cloud computing environment, program modules may be located in both local and remote computer system storage media including memory storage devices.

Computer system/server 12 is in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable and volatile/non-volatile computer system storage media. By way of example only, storage system 34 can be provided for reading from and writing to a non-removable, non-volatile magnetic media (not shown and typically called a ‘hard drive’). Although not shown, a magnetic disk drive for reading from and writing to a removable, non-volatile magnetic disk (e.g., a ‘floppy disk’), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (for example, at least one) of program modules that are configured to carry out the functions of embodiments of the invention.

Rule management system 40 is stored in memory 28.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems.

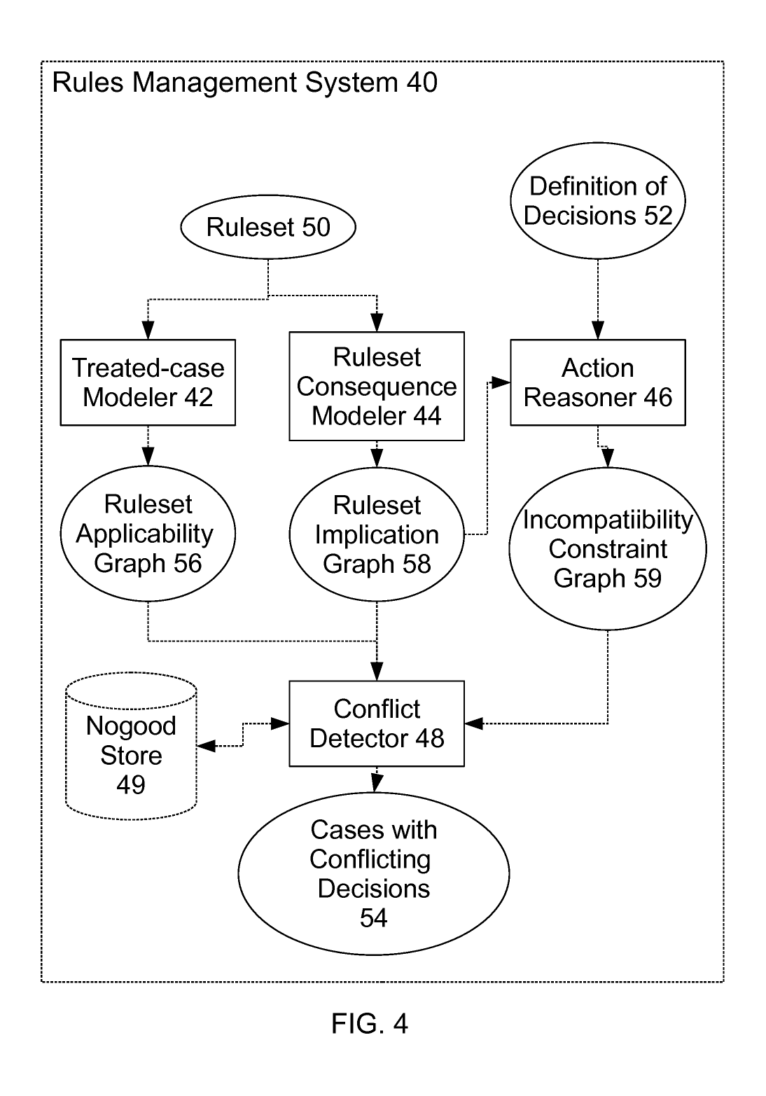

FIG. 4 is a component diagram of rules management system 40 of the preferred embodiment. Rules management system 40 takes a ruleset 50 and a set of definitions of decisions 52 (or a set of incompatibility constraints) as input and computes a family of similar cases with conflicting decisions 54. Rules management system 40 comprises: treated-case modeler 42; ruleset consequence modeler 44; action reasoner 46; conflict detector 48; and a nogood store 49.

Components 40-49, shown in rectangular boxes in FIG. 4, interact with inputs and outputs 50-59, shown in ovals in FIG. 4.

Treated-case modeler 42 transforms ruleset 50 input into a ruleset applicability graph 56 output that describes the treated cases of the ruleset in a compact logical and constraint-based form. Treated-case modeler 42 builds a constraint graph that represents the treated cases and actions of a ruleset in an implicit form as a data tree structure having a root node and child nodes connected by edges. The cases and actions are formed of logical expressions and the treated-case modeler 42 recursively traverses the logical expressions of each rule in the ruleset, a rule comprising and maps each visited logical expression to a node in the graph. It guarantees a unique representation, that is, two occurrences of the same expression are mapped to the same graph node. Treated-case modeler 42 maps primitive expressions such as numbers, string literals, and objects matched by the rules to leaf nodes and it maps composed expressions such as arithmetic operations, comparisons, accesses to attributes of objects to inner nodes which are labelled by an operator and which have outgoing edges to the nodes that represent their expressions. Leaf nodes that represent an object matched by the rule are canonically renamed by type and number for each rule to reduce the size of the graph. For example, if the rule matches an object called ‘the loan’ then the modeler renames it into ‘Loan1’. Treated-case modeler 42 constructs the ruleset applicability graph of a ruleset by introducing a graph node that represents the conjunction (an ‘and’ logical operation) of tests of this rule and that has outgoing edges to the nodes representing these tests. Finally, treated-case modeler 42 introduces the root node of the ruleset applicability graph 56 which represents the disjunction of the different rule applicability graphs and which has outgoing edges to the nodes representing these rule applicability graphs. A ‘treated-case’ is a graph having logical labels ‘true’ or ‘false’ for graph nodes that respect the logical operations of the other graph nodes. A treated-case is one where a root node is labelled by ‘true’. Treated-case modeler 42 only takes the condition of the rule into account and not the action of a rule.

Ruleset consequence modeler 44 transforms ruleset 50 input into ruleset implication graph 58 output. Ruleset implication graph 58 describes which actions are executed by the ruleset for which case.

Action reasoner 46, given the ruleset implication graph 58 input and decision definitions 52 input, derives incompatibility constraint graph 59 output in this graph. Incompatibility constraint graph 59 is a constraint graph that describes incompatibility and constraints among actions that occur in the rule set.

Conflict detector 48 uses ruleset applicability graph 56, ruleset implication graph 58, and incompatibility constraint graph 59 as inputs to compute the family of cases with conflicting decisions 54 output.

Nogood store 49 is maintained for discarding families of cases without conflicting decisions and for discarding families of cases with conflicting decisions that have already been recorded. The second kind of nogoods permits an iteration of the whole method and thus the computation of several or all family of cases with conflicting decisions.

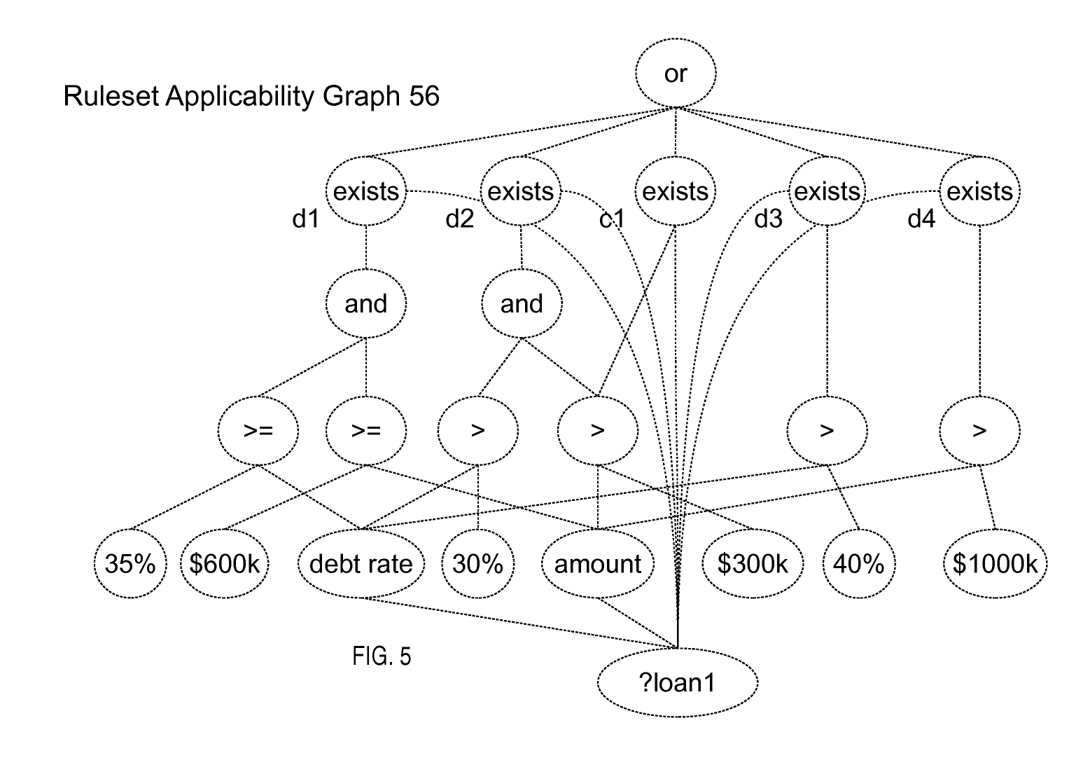

FIG. 5 is an example ruleset applicability graph 56, built by treated-case modeler 42 for describing the cases treated by the ruleset in a compact logical form. Ruleset applicability graph is a constraint graph that represents a disjunction of the applicability graphs of the individual rules, the rule applicability graphs. The applicability graph of a rule states that objects exist in the case that are matched by the rule and that satisfy the condition of the rule. A rule applicability graph thus represents an existential quantification of a logical formulation of the rule condition. FIG. 5 depicts the ruleset applicability graph for the example rules d1, d2, d3, d4, c1. For the sake of readability, the graph has been slightly simplified by omitting the condition that variable ‘?Loan1’ has the type loan.

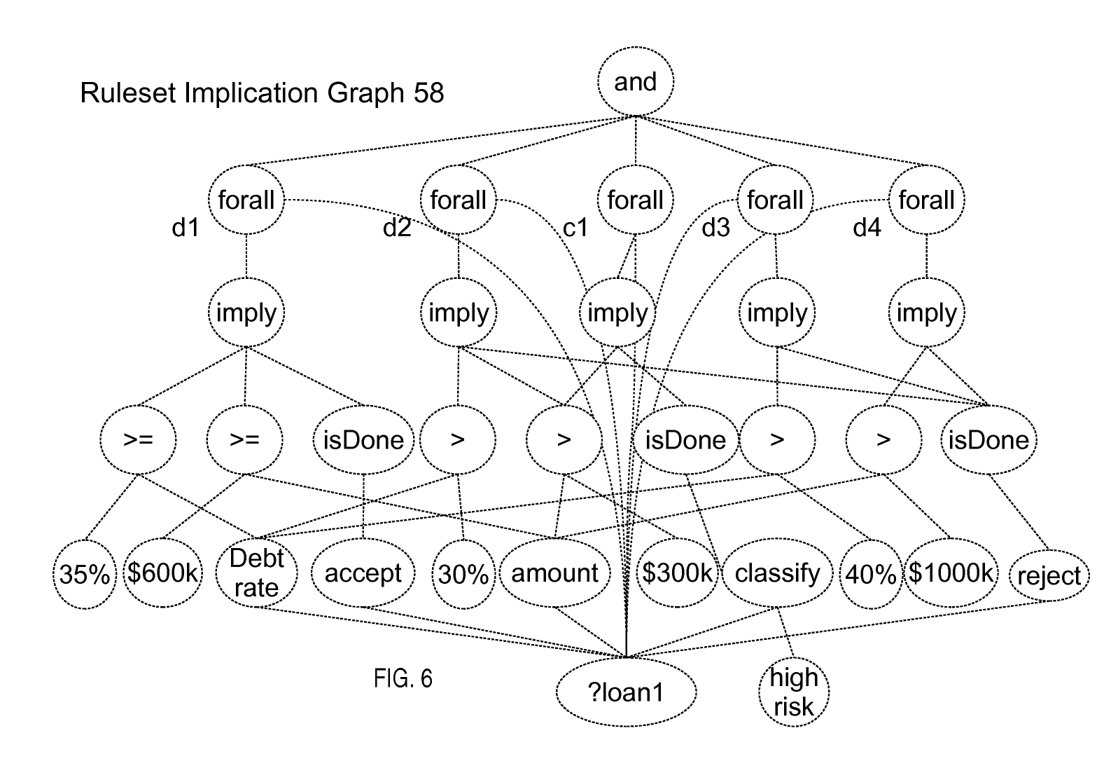

FIG. 6 is an example ruleset implication graph 58, built by ruleset consequence modeler 44, for describing that the actions of the applicable rules will be executed by the ruleset. Ruleset implication graph 58 is a constraint graph that represents the conjunction of the implication graphs of the individual rules (d1, d2, d3, d4, c1). The implication graph of a rule describes that, for all objects in the case that are matched by the rule, the rule action will be executed by the ruleset if the matched objects satisfy the rule condition. The implication graph thus represents a universal quantification of an implication represented by the imply node for each rule. This logical formulation represents actions as logical terms and it uses a unary predicate ‘isDone’ to indicate that an action is executed by the ruleset. For example, rule d1 has an implication graph that states that, for all (‘see node forall’) objects x of type loan (see connection from d1 graph node ‘forall’ to graph node ‘?loan1’), the action ‘accept x’ is done if x is a loan and the debt rate of x is at most 35% and the amount of x is at most $600,000 (see d1 graph nodes ‘isDone’ and ‘accept’ and connections to graph node ‘?loan1’). The remaining arguments of the implication represent the logical formulation of the rule condition (see d1 graph nodes ‘>=’ connected to graph nodes ‘35%’ ‘debt rate’ and ‘$600 k’ ‘amount’ respectively. The graph has been slightly simplified by omitting the condition that variable ‘?Loan1’ has the type loan.

Ruleset implication graph 58 is similar to a ruleset application graph that models actions (unlike the ruleset applicability graph of the present embodiment that does not model actions) but also different in a subtle way. A ruleset application graph describes that some rule is applicable and that its action has been executed, whereas the ruleset implication graph describes that the action of an applicable rule will be executed. Given a case, a ruleset application graph states that the action of some applicable rule will be executed, whereas the ruleset implication graph states that the actions of all applicable rules will be executed. The first statement models the actual decision-making behavior of a rule engine as this engine executes one applicable rule. Such a model of the actual decision-making behavior is important for a redundancy analysis. A conflict analysis, however, needs a model of a fictive behavior which consists in applying all applicable rules. It is this fictive behavior that reveals the conflict that remains hidden in the actual behavior of the rule engine.

An incompatibility constraint graph 59 (aka constraints on action graph) is built by action reasoner 46 taking a definitions of decisions 52 (optionally also specifications of incompatibility constraints) as input. Action reasoner 46 also receives requests from the conflict checker to check the compatibility of given actions on a need by need basis. Action reasoner 46 may also inspect the ruleset implication graph to extract the relevant actions to check. For example, action reasoner 46 may receive three actions, namely ‘accept Loan1’, ‘reject Loan1’, and ‘classify Loan1 as high risk’. It examines the compatibility constraints given before (or the decision definitions) and determines that the actions ‘accept Loan1’ and ‘reject Loan1’ are incompatible. It therefore creates an incompatibility constraint graph that uses the predicate ‘isDone’ to state that one of these actions cannot be done. Hence, this graph represents the constraint ‘accept’ ‘Loan1’ is not ‘done’ or ‘reject’ ‘Loan1’ is not ‘done’.

Action reasoner 56 is also for managing information about action statements and for using that information to compare composite actions such as sequences of more elementary actions. If these action sequences make use of variables to store intermediate results of calculations, then action reasoner 56 will substitute those variables by the intermediate results where necessary. If action reasoner 46 has to check the compatibility of two composite actions such as ‘accept Loan1; classify Loan1 as high risk;’ and ‘classify Loan1 as high risk; reject Loan1;’, it will try to transform these action sequences into an adequate form that permits a comparison. For example, it may reorder the elementary actions of the first sequence into ‘classify Loan1 as high risk; accept Loan1;’ as none of the elementary action influences the other one. Action reasoner 46 can then detect that the reordered actions sequence and the second action sequence are incompatible as their final elements are incompatible and their initial elements are the same.

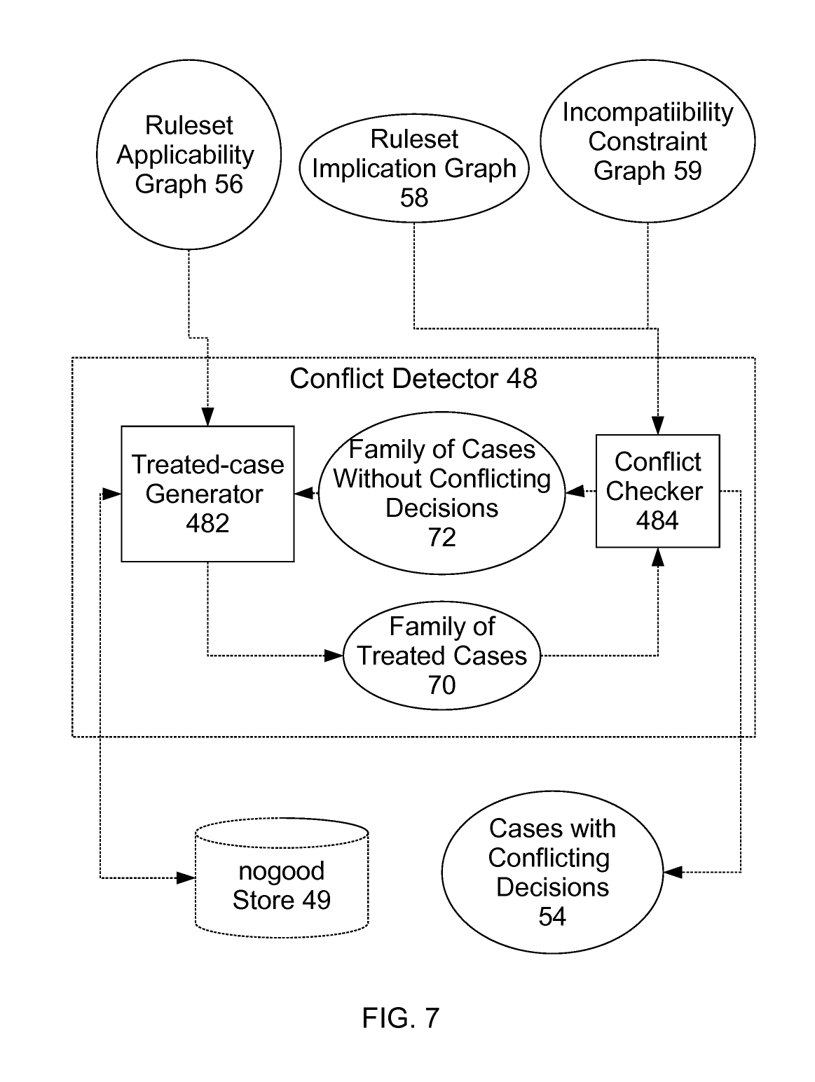

FIG. 7 is a component diagram of conflict detector 48 including interactions between the components. Conflict detector 48 is for pursuing a generate-and-test method to determine a family of cases with conflicting decisions. Conflict detector 48 comprises: treated-case generator 482 and a conflict checker 484.

Treated-case generator 482 uses ruleset applicability graph 56 to generate a family of treated cases 70, that is, a set of cases that make some rule in the ruleset applicable. This family can be quite general and, for example, include all cases treated by some of the rules.

Conflict checker 484 then determines whether this family contains only cases that have conflicting decisions. It uses the ruleset implication graph 58 for this purpose and it requests incompatibility constraints 59 on actions occurring in this graph from the action reasoner 46. If conflict checker 484 is able to prove within given time limits that the conjunction of a family of treated cases 70, the ruleset implication graph 58, and the incompatibility constraints 59 on actions do not have any solution, then it has shown that each case in the family of treated cases 70 has conflicting decisions. Conflict detector 48 therefore returns this family of treated cases 70 as its result, cases with conflicting decisions 54. If, however, the conflict checker 484 was able to find a solution within given time limits, then it has found a case in the family of treated cases that has no conflicting decisions. Conflict detector 48 seeks to eliminate this case and all similar cases that have no conflicting decisions. For this purpose, the conflict checker 484 generalizes the case without conflicting decisions into a family of cases without conflicting decisions 72, which is described by a set of tests (or constraints), and communicates it to the treated-case generator 482. Necessarily the family of cases without conflicting decisions 72 is a subset of the corresponding family of treated cases 70. In the preferred embodiment conflict checker 484 considers treated family of cases as a limited number of subsets and picks a subset of cases that includes the found case without a conflicting decision. This subset becomes the family of cases without conflicting decisions 72.

Treated-case generator 482 eliminates the cases in the family of cases without conflicting decisions 72 by marking them and the corresponding family as nogood. Nogood families of cases are families of cases that are forbidden. A case does not belong to a nogood family if it violates at least one test among the tests that characterize the nogood family. Treated-case generator 482 puts the nogood family of cases into the nogood store 49, which is initially empty. When computing a new family of treated cases, the treated-case generator 482 ensures that the cases in the generated family are not in the nogoods store 49, that is, none of the cases in the newly generated family belongs to any of the nogood families. If treated-case generator 482 does not find any new family of treated cases since all those families have been discarded, the method stops signaling that no family of cases with conflicting decisions has been found.

A particular situation arises if one of these components runs into a time limit. If the treated case generator 482 does not find any family of treated cases, the whole method simply stops without reporting any family of cases with conflicting decisions. However, if the conflict checker neither finds a case without conflicting decisions within the given family, nor is able to prove the absence of cases without conflicting decisions, then the process can be continued by discarding the whole family of treated cases.

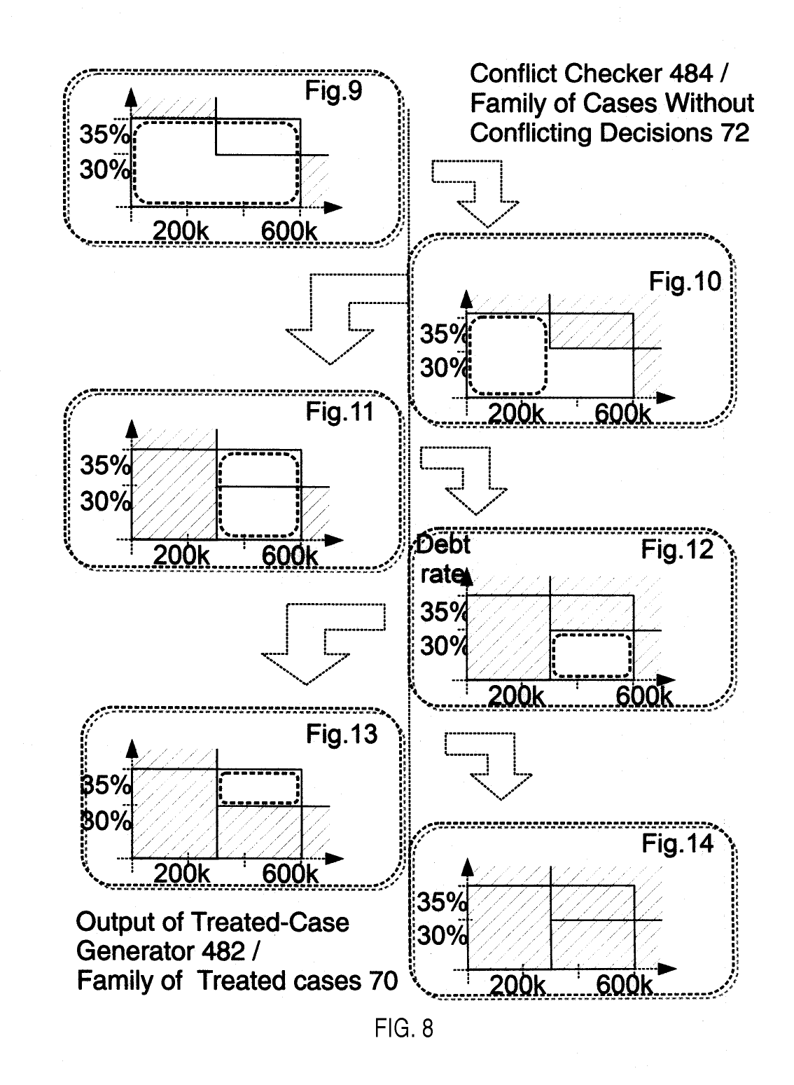

FIG. 8 illustrates an overview of execution trace steps of the conflict detector for the ruleset given in FIG. 1. The left column shows stages of the family of treated cases 70 after the operation of treated-case generator 482. The right column shows stages of the family of cases without conflicting decisions 72 after the operation of conflict checker 484. Each operation consists in computing a family of cases that respects certain characteristics.

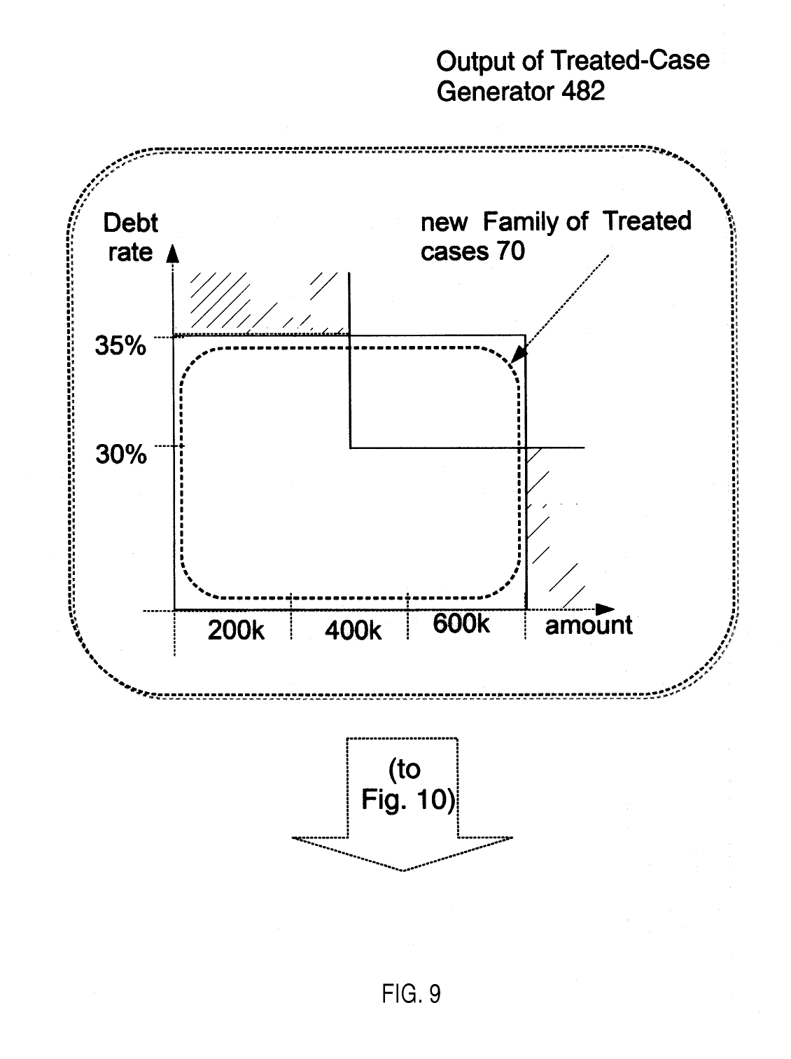

FIG. 9 to FIG. 14 show a respective operation of FIG. 8 in more detail. In FIG. 8 to FIG. 14 the operations bounded by rounded rectangles show a part of the case space defined either by the conflict checker 484 or by the treated-case generator.

Referring to FIG. 9 and the upper left graph in FIG. 8, the nogood store 49 is initially empty, meaning that the treated-case generator 482 may produce any family of treated cases. In this example, it determines a family of treated cases that consist of a single loan object Loan1. The family contains all cases for which the amount of this object is at most $600 k and the debt rate is at most 35%. This family of treated cases 70 can be described by the following tests (or constraints):

the amount of Loan1 is at most $600 k

the debt rate of Loan1 is at most 35%

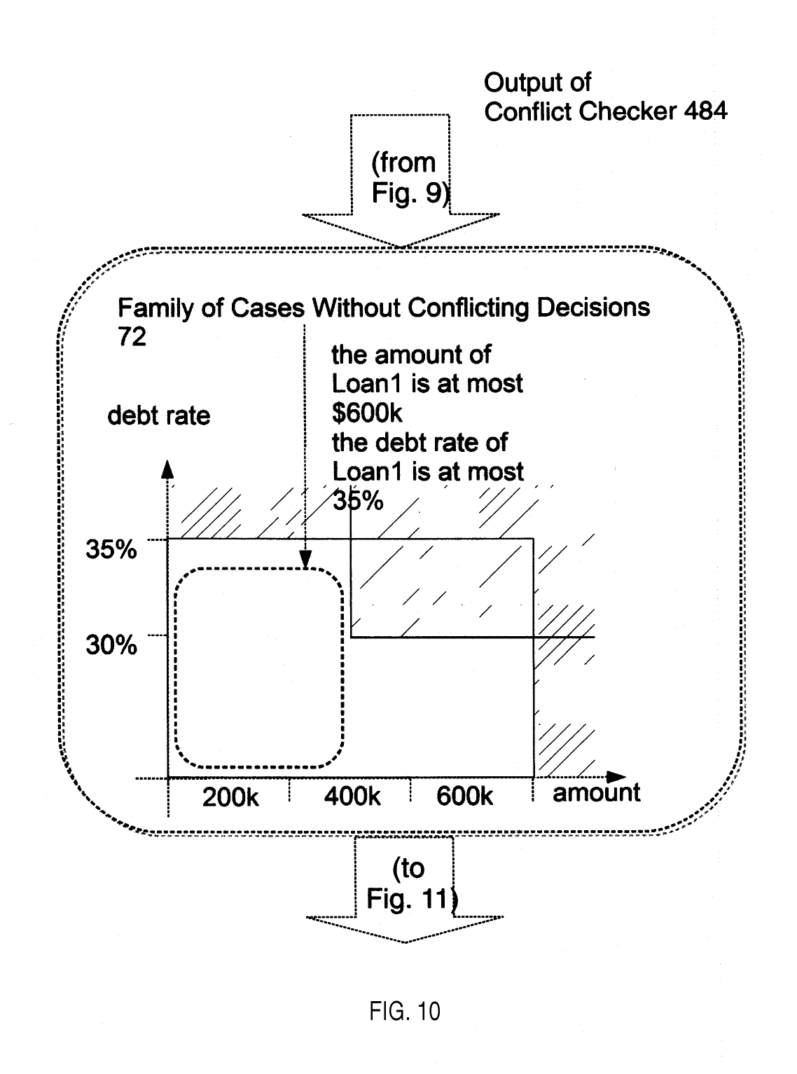

Referring to FIG. 10 and the upper right graph in FIG. 8, the treated-case generator 482 passes this description to conflict checker 484. As the conflict checker 484 may consider only cases in this family, all other areas are crossed out in the case space. Conflict checker 484 finds a case without conflicting decisions and generalizes it into the following family of cases without conflicting decisions:

the amount of Loan1 is at most $300 k

the debt rate of Loan1 is at most 35%

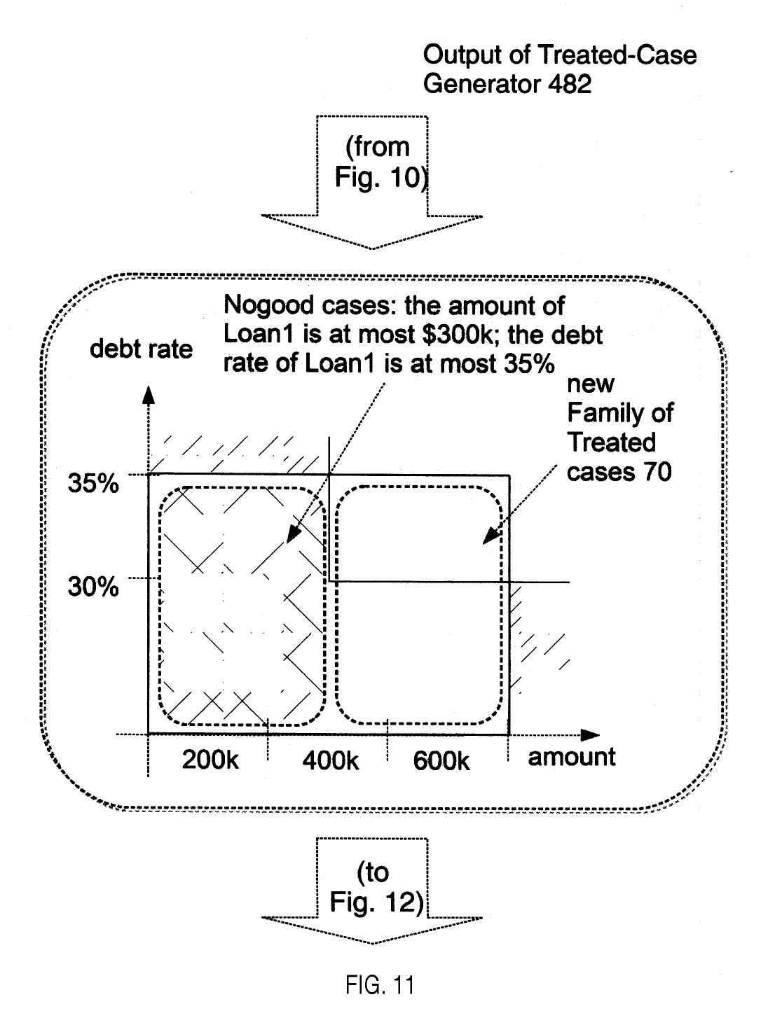

Referring to FIG. 11 and the middle left graph in FIG. 8, treated-case generator 482 transforms the family of cases without conflicting decisions into nogood cases in order to discard all elements of this family. The discarded nogood family is indicated by the crossed hatching and the definition:

the amount of Loan1 is at most $300 k and

the debt rate of Loan1 at most 35%

Next, the treated-case generator 482 produces a new family of treated cases, which satisfies the nogood and thus does not include any of the discarded cases:

the amount of Loan1 is at most $600 k

the amount of Loan1 is more than $300 k

the debt rate of Loan1 is at most 35%

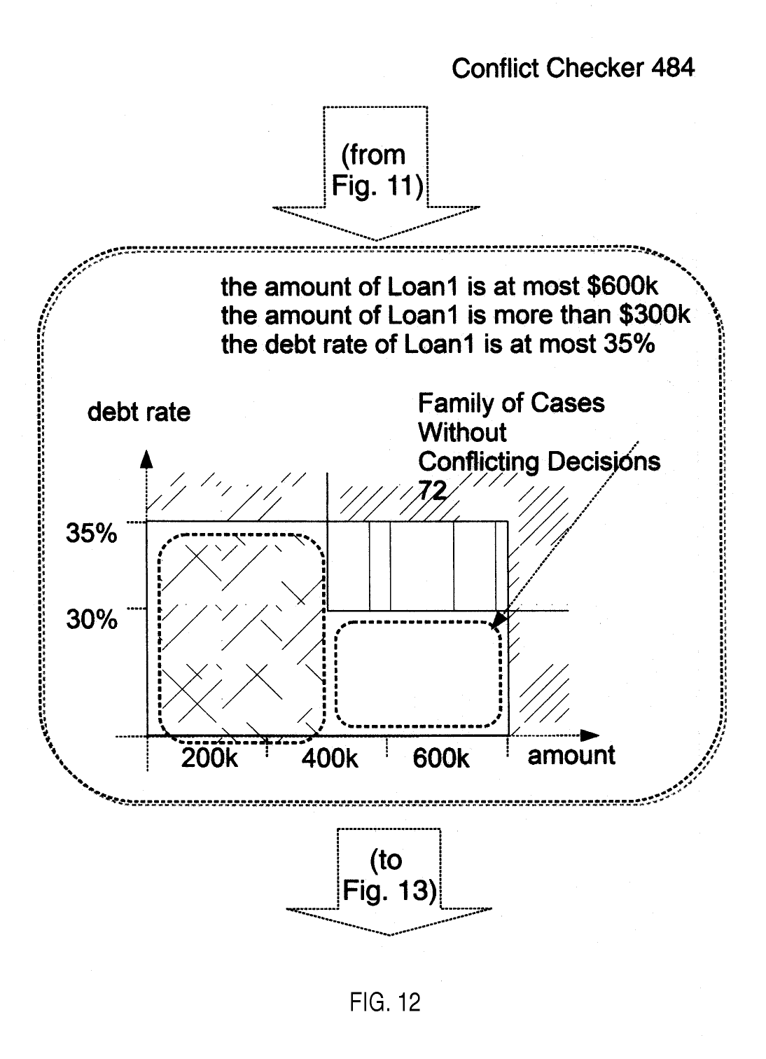

Referring to FIG. 12 and the middle right graph in FIG. 8. When communicated to conflict checker 484, the checker finds a new family of cases without conflicting decisions 72. Although the cases in this family make two rules applicable, namely d1 and c1, the conflict checker is able to find a solution since the actions of these rules are not in conflict:

the amount of Loan1 is at most $600 k

the amount of Loan1 is more than $300 k

the debt rate of Loan1 is at most 30%

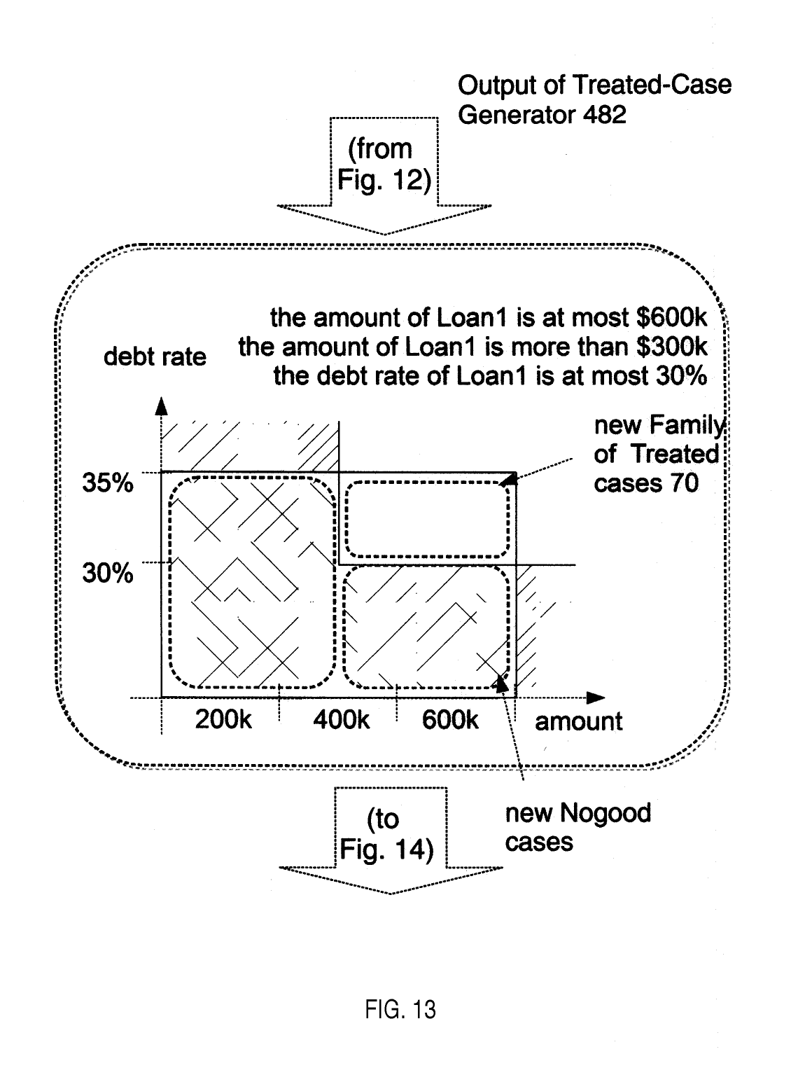

Referring to FIG. 13 and the lower left graph in FIG. 8. Again conflict checker 484 sends this family to treated-case generator, which discards it by creating a nogood for it. The discarded family is crossed out and labeled as a new nogood family. Treated-case generator 482 finds a third new family of treated cases 70:

the amount of Loan1 is at most $600 k

the amount of Loan1 is more than $300 k

the debt rate of Loan1 is at most 35%

the debt rate of Loan1 is more than 30%

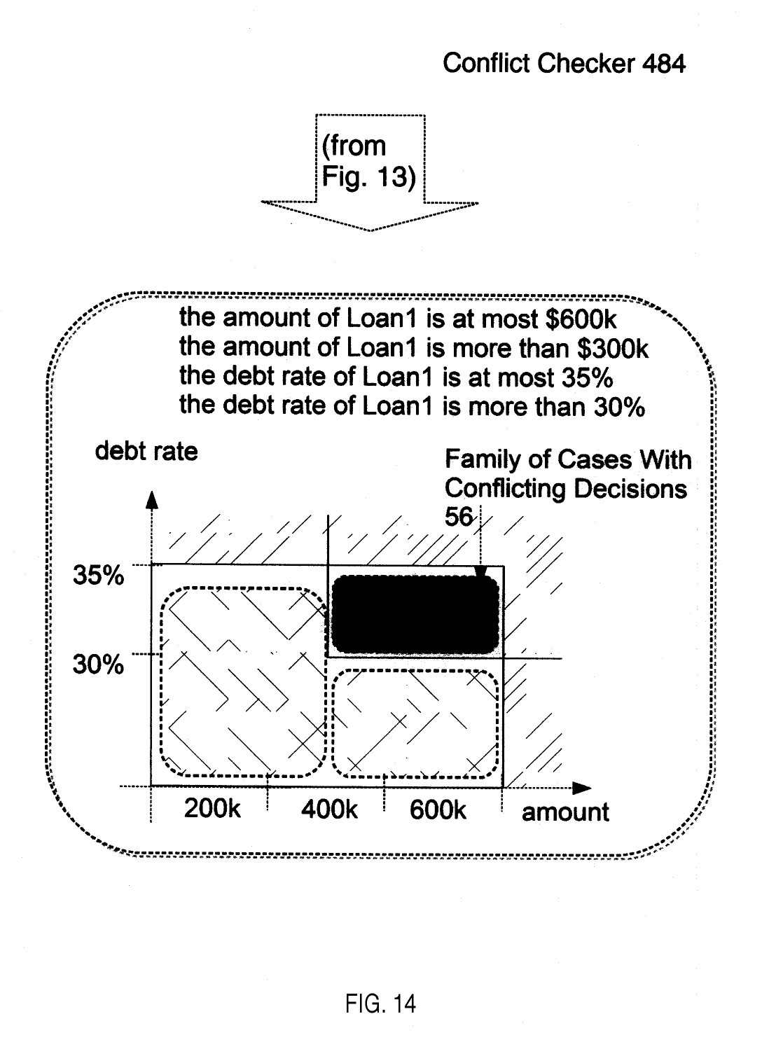

Referring to FIG. 14 and the lower right graph in FIG. 8, conflict checker 484 is not able to find a case without conflicting decisions in this family. Indeed, each case in this family makes rules d1 and d2 applicable and these rules execute the actions ‘accept Loan1’ and ‘reject Loan1’, which are incompatible. As such, the system has found the family of cases with conflicting decisions 56.

The preferred embodiment provides a logical description of condition-action rules as well as incompatibility constraints among the actions of those rules but another embodiment could use an abductive engine to abduce these incompatibility constraints.

Such an abductive embodiment would use an abductive approach described in the article ‘Expressive policy analysis with enhanced system dynamicity’ by Robert Craven et al. This work finds conflicts among rules expressing access-control policies, which either permit or deny an action. The approach expresses the rules in a logical language and uses an abductive engine to find cases that both permit and deny some action. The abductive engine thus tries to prove the goal that some action is permitted and denied by working through a space of proofs.

The abductive engine works through a space of proofs, whereas the conflict detector works through a space of cases by solving a series of satisfiability problems. Both may have their respective advantages depending on the characteristics of the problems. It should be noted that the principle of abductive engines, namely consequence finding, dates back to the article ‘A Note On Linear Resolution Strategies in Consequence-Finding’ by R. Reiter and E. Minicozzi, which has been published in the journal ‘Artificial Intelligence’ in 1972, whereas it was not known how to solve those problems by a well-chosen series of satisfiability problems. The latter approach is of advantage if there are many incompatibility constraints and if there are many cases with conflicting decisions.

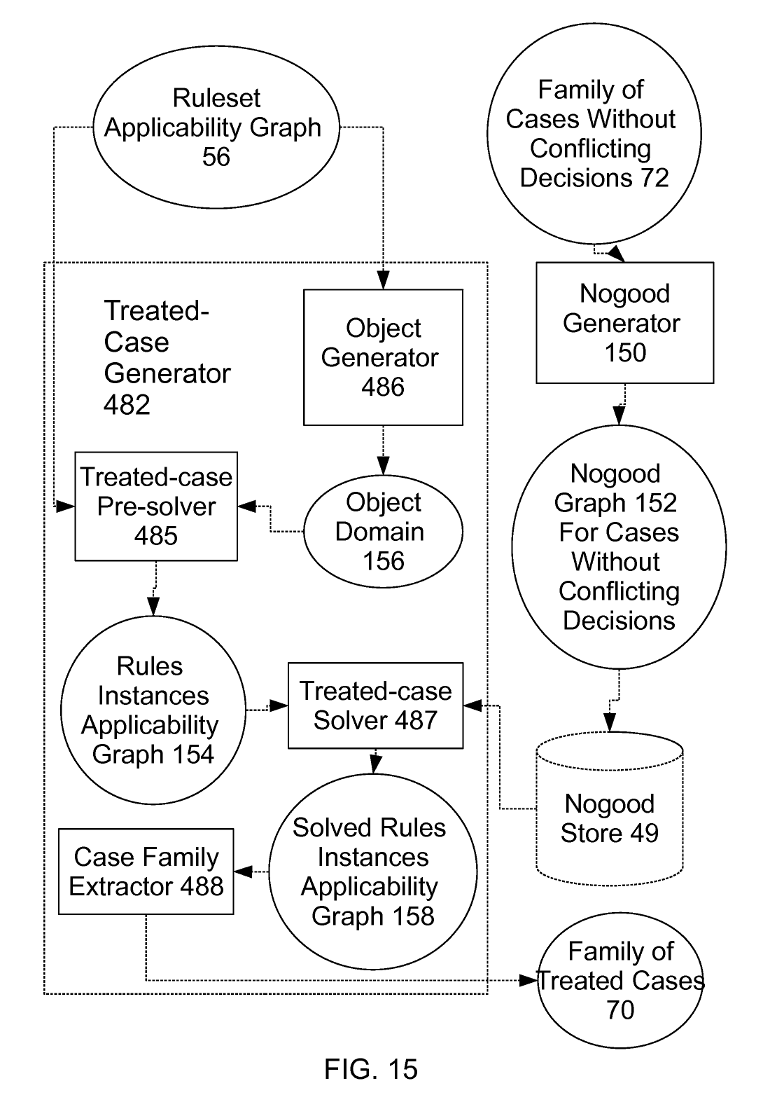

FIG. 15 is a component diagram of treated-case generator 482. Treat-case generator 482 comprises: treated-case pre-solver 485; object generator 486; treated-case solver 487; and case-family extractor 488. Treat-case generator 482 input is ruleset applicability graph 56, nogood store 49, and when supplied, family of cases without conflicting decisions 72. If family of cases without conflicting decisions 72 is supplied, then a nogood generator 150 builds a nogood graph 152 which represents the disjunction of the negation of the tests that constitute the description of the family. Treated-case generator 482 adds nogood graph 152 to the nogood store 49 before it is supplied to the treated-case generator 482.

Treated-case pre-solver 485 is for building rule instances applicability graph 154 given the ruleset applicability graph 56. The purpose of this is to eliminate existential quantifiers in the ruleset applicability graph 56 whereby an existentially quantified constraint is replaced by a disjunction of quantifier-free constraints. The existentially quantified constraint expresses that a rule will match some objects in a case that satisfy the rule condition. If a case consists of several objects, that is, several loan requests named Loan1 and Loan2, and then a rule such as d1 will have two instances. The first instance matches Loan1 and the second instance matches Loan2. The rule d1 will then treat a case consisting of Loan1 and Loan2 if its instance for Loan1 treats this case or if its instance for Loan2 treats this case. Treated-case pre-solver 485 replaces the statement that some instance of d1 treats the case by the statement that the instance of d1 for Loan1 treats the case or that the instance of d1 for Loan2 treats this case.

Object generator 486 creates a sufficient number of objects for each type by inspecting the rule scopes, that is, the number and types of the objects matched by each rule. The object generator returns an object domain 156 such as the domain {Loan1, Loan2}, which contains two objects of type loan. Treated-case pre-solver 485 then chooses an object from this domain for each variable of an existentially-quantified constraint and instantiates the constraint by substituting each occurrence of a variable by the chosen value. It creates such an instance for each combination of values that can be used to substitute the variables. It then builds the disjunction of all these instances and thus obtains a rule instances applicability graph for a single rule. It proceeds in this way for all rules and builds the overall rules instances applicability graph 154 for the complete ruleset by building the disjunction of the rule instances applicability graphs of the individual rules.

Whereas a case may have an unbounded number of objects, only a limited number of objects are necessary for carrying out a conflicting rules analysis. As it is sufficient to consider conflicts between two rules, it is not necessary to analyze all objects occurring in a case, but only a sufficient number for matching two rules. Object generator 486 inspects each type of object that is matched by some rule and determines the maximum number that an object of this type is matched by a rule. If all rules match a single object of type loan, the maximum number of matches for type loan is one. If there is a rule that matches two objects of type loan then this number is two. Object generator 486 then needs to generate as many objects of each type as indicated by this maximal number in order to ensure that each rule matches objects in this resulting object domain. In order to ensure that two rules match different objects, object generator 456 needs to generate twice as many objects, that is, the double of the maximal number. This will ensure that the method is complete, but may significantly increase the number of instances of constraints. A good strategy consists in starting with a small set of objects and to carry the analysis out for this small set. Once finished, the method can be repeated for a larger set, knowing that the number of objects is bounded by the double of the maximum number that a rule matches an object of this type.

As the rules d1, d2, d3, d4, c1 all match a single loan object, it is sufficient to create a single loan object, called Loan1, in a first phase and to create instances of the existentially-quantified applicability constraint for this object. Treated-case pre-solver 485 will then replace all existentially-quantified applicability constraints in this way and create a quantifier-free rule instances applicability graph.

Treated-case solver 487 is for labeling rules instances applicability graph 154 such the labels are consistent with the root nodes while respecting the operations expressed in the graph. Treated-case solver 487 uses search and inference methods as are known in constraint programming and propositional theorem proving.

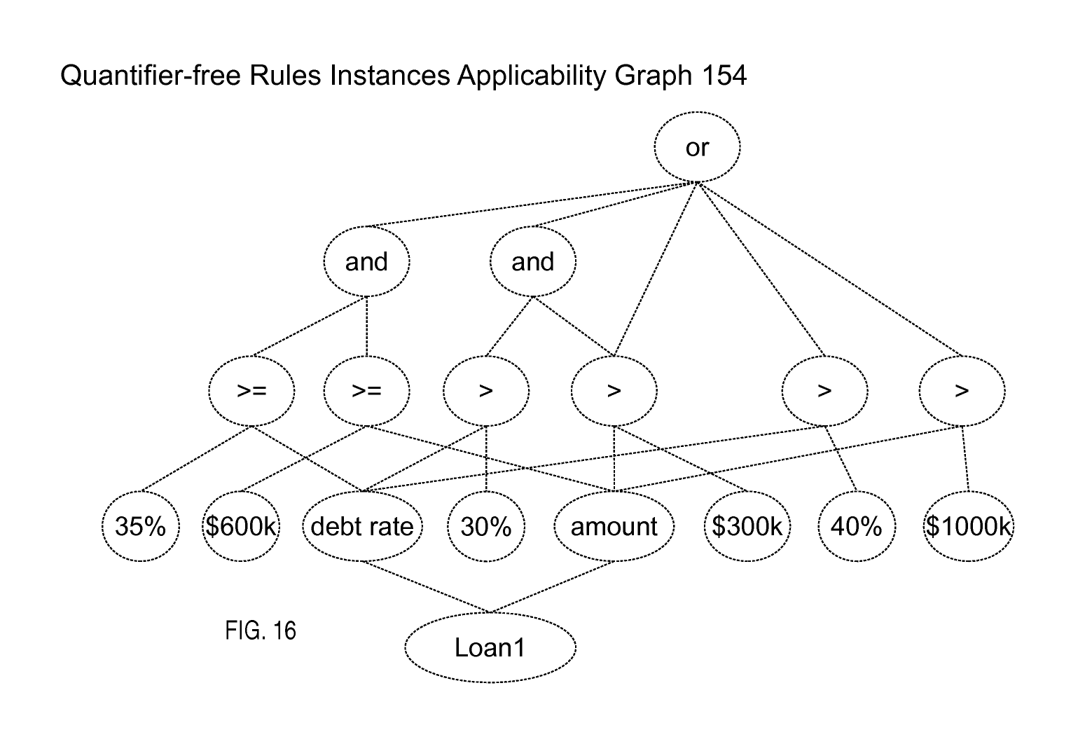

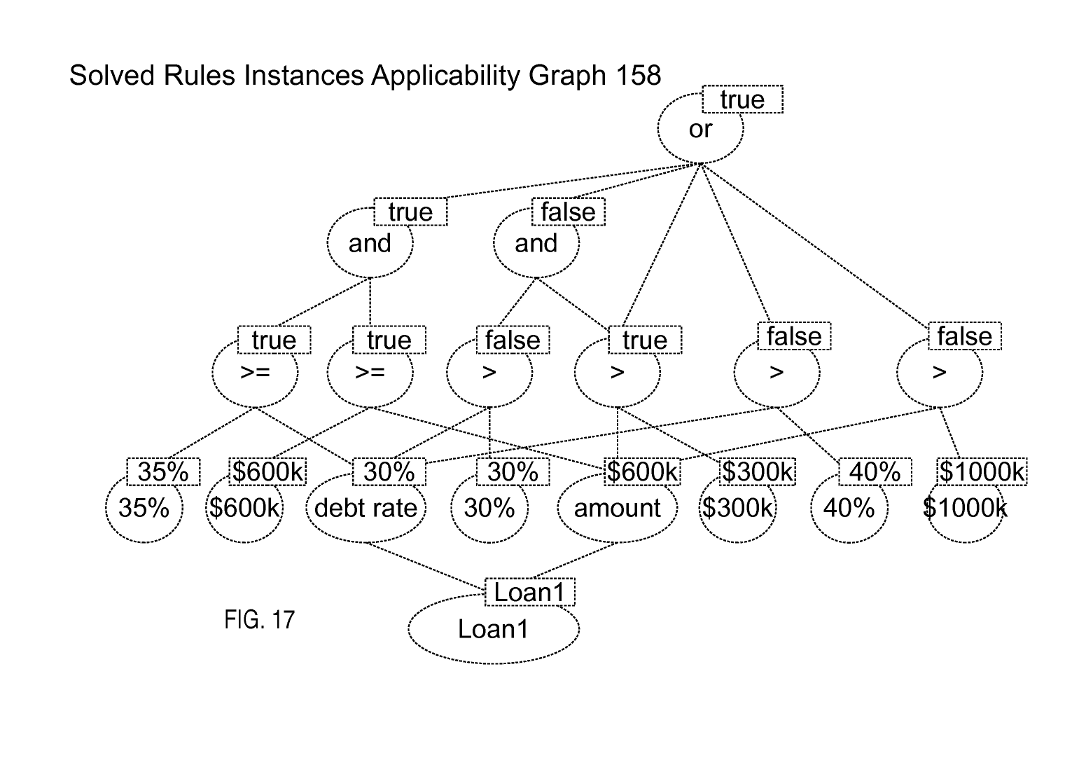

FIG. 16 is an example of a quantifier-free rules instances applicability graph 154. Treated-case generator 482 sends rule instances applicability graph 154 and nogood graph 152 to a treated-case solver 487. If the treated-case solver 487 does not find consistent labeling within given time limits, the whole analysis process stops and the conflict detector signals that it has not found any family of cases with conflicting decisions that respect the nogoods in the nogood store 49. If treated-case solver 487 finds consistent labeling then it returns a solved rules instances applicability graph 158 as shown in FIG. 17.

FIG. 17 is a solved rules instances applicability graph 158 for the example of FIG. 16.

Case-family extractor 488 is for extracting a family of similar cases from a solved rules instances applicability graph 158. The extractor inspects the children of the root node and selects one child that is labeled true. As the root node represents a disjunction, it is sufficient to find one disjunct that is true in order to ensure that the entire disjunction is true. The extractor then inspects all elementary tests that are descendants of the node representing this disjunct. In the solved graph, the following tests are both labeled true:

the debt rate of Loan1 is at most 35%

the amount of Loan1 is at most $600 k

Any case that satisfies these tests will thus ensure that the disjunct and thus the entire disjunction is labeled with true. Hence, any case that satisfies these tests is a treated case. As a consequence, the list of tests describes a family of treated cases 70 and the treated-case generator 482 returns it as its result. If nogoods are given, they need to be processed in the same way, thus adding further tests to the family description. If one of the relevant tests is labeled false, then its negation is added to the case-family description. Other strategies for extracting families of treated cases may process each test occurring in the solved graph and include it or its negation in the case-family description. Those strategies will produce more specialized families and thus lead to a different performance behavior of the conflict detector.

Once the treated-case generator 482 has computed a new family of treated cases 70, it sends it to conflict checker 484.

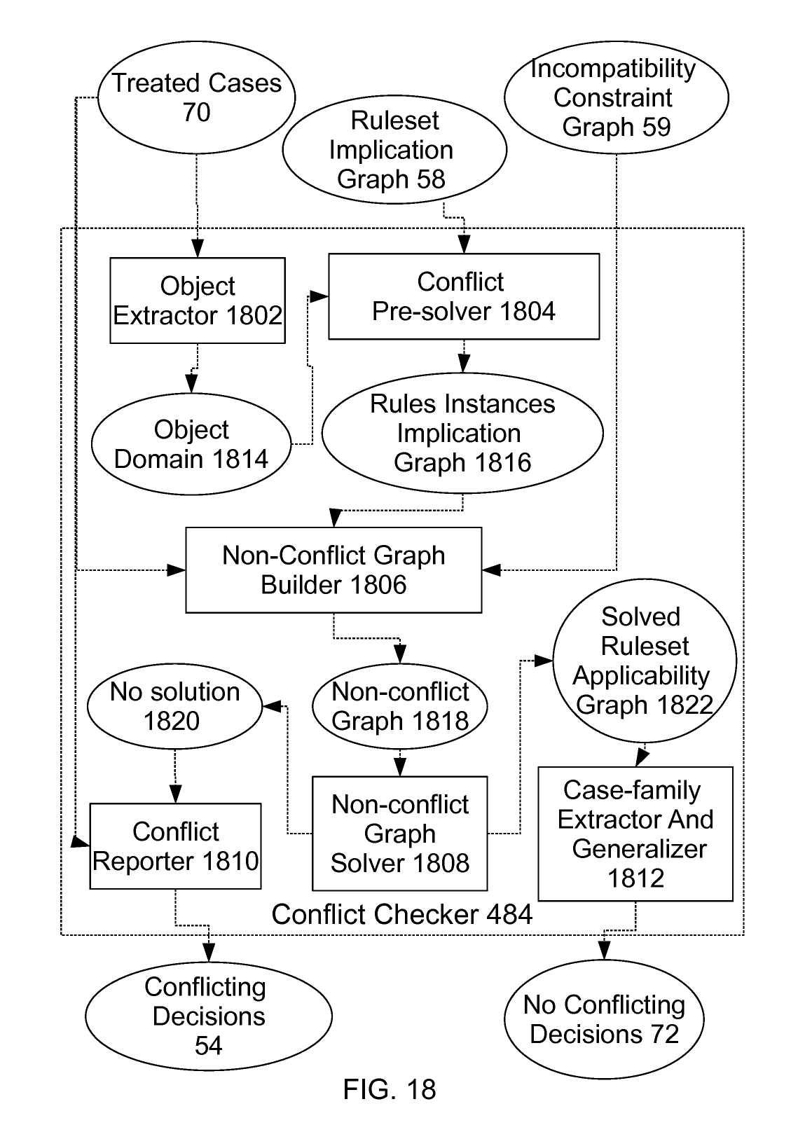

FIG. 18 is a component diagram of conflict checker 484 and the interaction of its principal components. Conflict checker 484 comprises: object extractor 1802; conflict pre-solver 1804; non-conflict graph builder 1806; non-conflict graph solver 1808; conflict reporter 1810; case-family extractor and generalizer 1812.

Object extractor 1802 is for building an object domain 1814 of all objects occurring in the family of treated cases. This is a subset of the object domain constructed by the treated-case generator 482.

Conflict pre-solver 1804 is for instantiating all universally quantified constraints in the ruleset implication graph 58 using object domain 1814. It chooses a value from object domain 1814 for each variable of the quantified constraint and then substitutes all occurrences of the variables by the chosen value, thus generating a quantifier-free instance of a rule implication graph. It generates an instance for each possible value assignment between the variables of the quantified constraint and the object domain. Then the pre-solver builds a conjunction of the resulting instances in order to produce a rule instances implication graph for a single rule. It processes all rules in this way and then builds the conjunction of the rule instances implication graph of each rule, thus producing a rules instances implication graph 1816 for the whole ruleset.

Non-conflict graph builder 1806 is for building a non-conflict graph 1818 which is the conjunction of the description of the treated-case 70, the rules instances implication graph 1816, and incompatibility constraints graph 59. The incompatibility constraints are requested from action reasoner 46. The non-conflict graph 1818 then represents all cases in the given family of treated cases that have no conflicting decisions. Non-conflict graph 1818 is submitted to non-conflict-graph solver 1808.

Non-conflict graph solver 1808 uses search and inference methods to find a labeling of the graph nodes that is true and that respects the operation of the graph nodes. If it finds such a labeling, it returns a solved non-conflict graph.

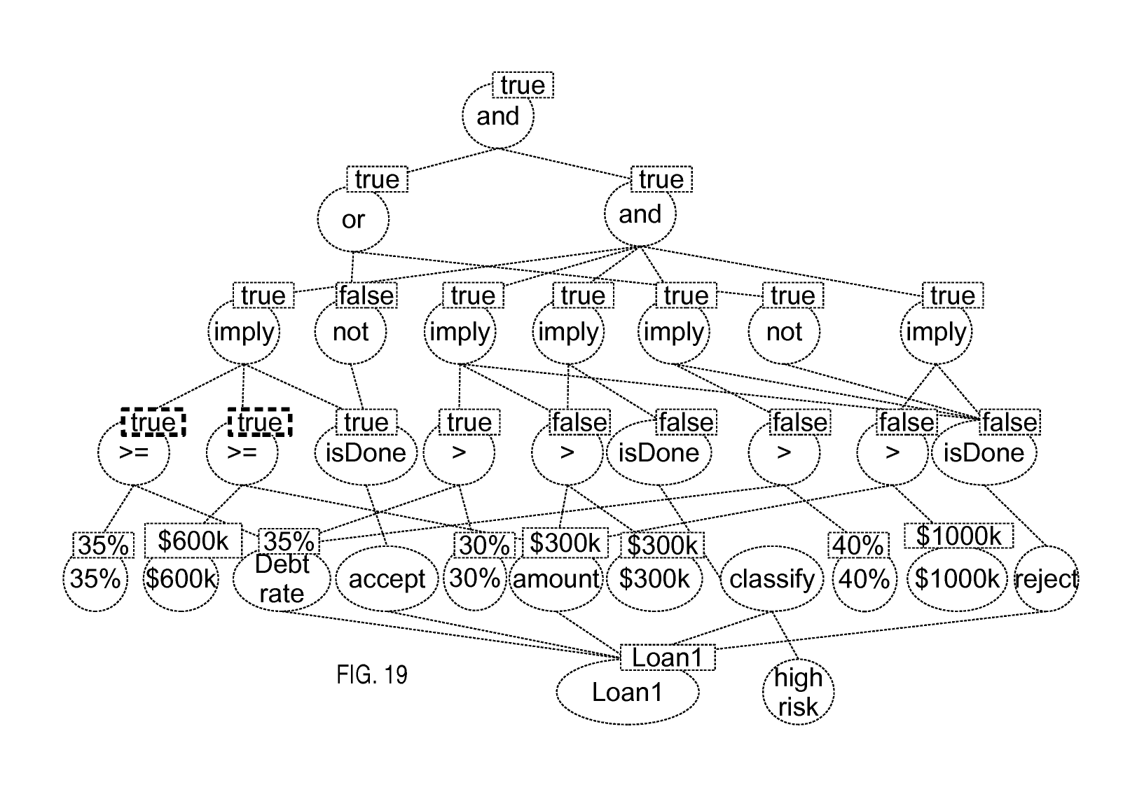

FIG. 19 shows an example solved non-conflict graph that corresponds to the solution found for the operation in FIG. 10. For the sake of readability, the node representing the family of treated cases has been omitted. The tests of the case-family description occur in the graph and these nodes have directly been labeled with ‘true’. As this label cannot be changed by the solver it is marked. FIG. 19 is a solved non-conflict graph showing the example label that cannot be changed marked by bold dotted lines.

As the labeling expresses the fact that there is a case without conflicting decisions, the conflict checker seeks to discard it and similar cases. For this purpose, it inspects the truth values of all nodes in the graph that represent elementary tests and that do not concern the predicate ‘isDone’. It produces a description of the conflict-free family of cases by including a test if it is labeled ‘true’ and by including the negation of a test if it is labeled ‘false’. For FIG. 19, this produces the description:

the debt rate of Loan1 is more then 30%

the debt rate of Loan1 is at most 35%

the debt rate of Loan1 is at most 40%

the amount of Loan1 is at most $300 k

the amount of Loan1 is at most $600 k

the amount of Loan1 is at most $1000 k

This family can optionally be generalized by using consistency-based explanation techniques, for example, by generalizing a family of missing cases by a detecting set of relevant tests in the description of the family and by removing the other tests. The relevant tests form a minimal set of tests that is inconsistent in conjunction with a ruleset applicability graph. To achieve a similar reduction for cases without conflicting decisions, the generalizer uses a negation of the rules instances implication graph. This step will allow the conflict detector to identify two relevant tests, namely:

the amount of Loan1 is at most $300 k

the debt rate of Loan1 is at most 35%

The conflict checker then sends this family of cases without conflicting decisions to the treated-case generator such that it discards it. If no generalization is used, then the treated-case generator will discard a smaller set of cases, which means that more iterations are needed to find a family of cases with conflicting decisions, but this does not affect the overall result of the method.

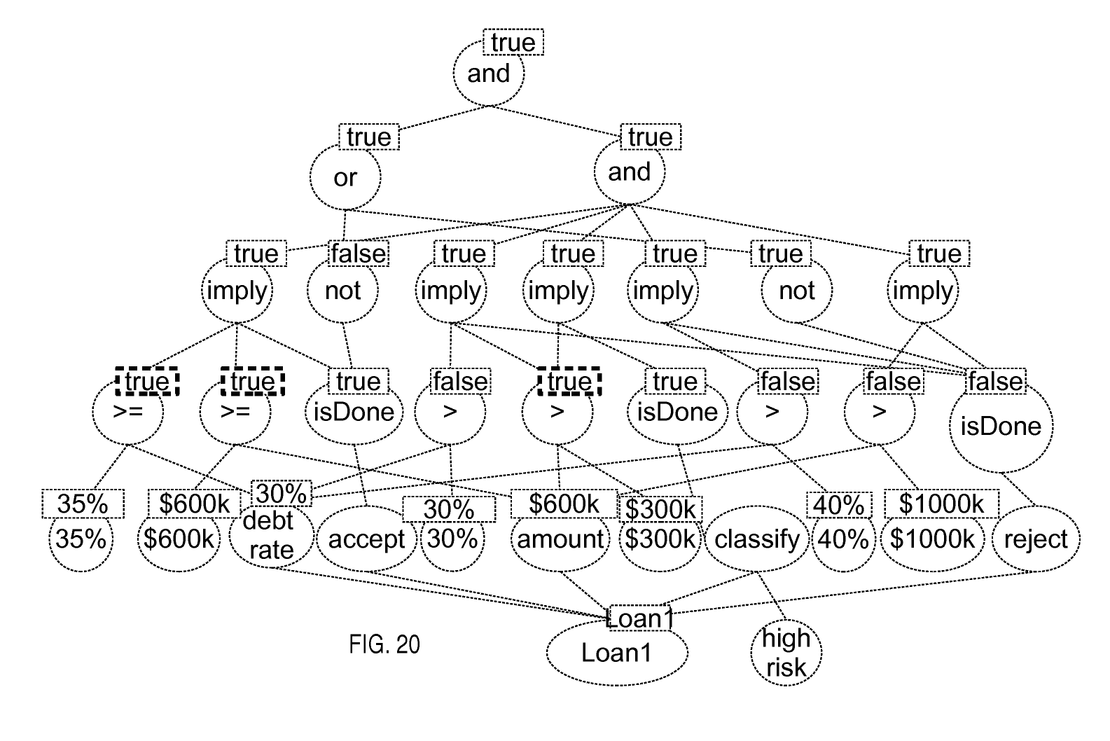

FIG. 20 is a solved non-conflict graph for the second iteration of the process depicted in FIG. 12. In this graph, two nodes labeled by the ‘isDone’ predicate are labeled ‘true’, namely the node representing ‘accept Loan1 is done’ and the node ‘classify Loan1 as high risk is done’. However, as these actions are compatible, no conflict is determined.

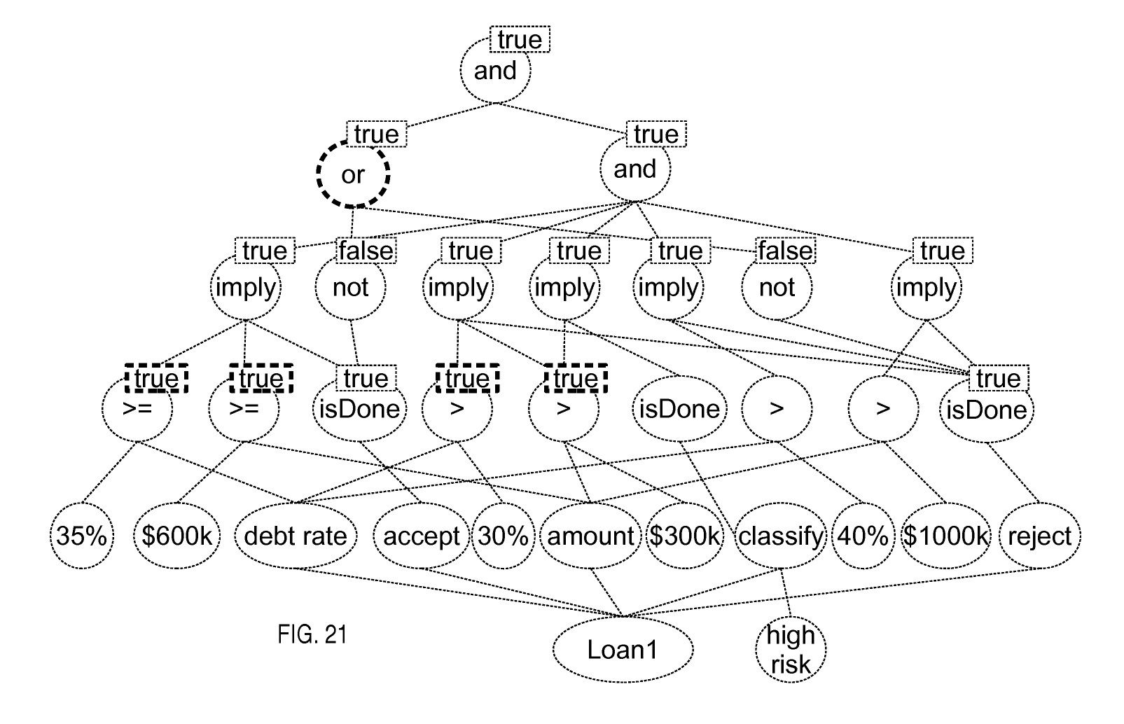

FIG. 21 is a non-conflict graph for the last iteration depicted in FIG. 14. The following family of treated cases is given as input in this step:

the amount of Loan1 is at most $600 k

the amount of Loan1 is more than $300 k

the debt rate of Loan1 is at most 35%

the debt rate of Loan1 is more than 30%

FIG. 21 is a graph indicting tests, which are labeled ‘true’ and as this labeling cannot be changed by the non-conflict graph solver it is marked by a bold and dotted lines. In order to label the root node of the graph with ‘true’, the nodes in the graph must be labeled in the way as indicated. However, this labeling violates the incompatibility constraint that expresses that ‘accept Loan1 is not done’ must be labeled ‘true’ or ‘reject Loan1 is not done’ must be labeled ‘true’. As these nodes are labeled with ‘false’ and no choice was made to derive this labeling, the non-conflict graph in 1 has no solution. Hence, the given family of treated cases contains only cases having conflicting decisions. Therefore, the conflict checker has found a family of cases with conflicting decisions and returns its description as its result.

A rule maker can then enter a rule of higher priority that imposes the desired treatment for this family. For example, the rule maker may decide to reject the loan request for those cases:

rule arbitrator1

definitions
set Loan1 to a loan,

if the amount of Loan1 is at most $600 k and
the amount of Loan1 is more than $300 k and
the debt rate of Loan1 is at most 35% and
the debt rate of Loan1 is more than 30%

then reject Loan1;

The rule maker may also split the family of conflicting cases into a subset for which the loan is accepted and another one for which the loan is rejected. Hence, the reported case with conflicting decisions contains the essential information for resolving the conflict. The rule maker can thus resolve the conflict by writing new rules of higher priority and this without needing to undertake a tedious investigation and modification of the existing rules. This facilitates and simplifies the whole conflict resolution process. Conflict resolution is here achieved by making particular decisions (and rules) for critical cases, but not by making adjustments among conflicting rules.

The entire method can be iterated to find further families of cases with conflicting decisions. For this purpose, the overall system creates a nogood that eliminates a family with conflicting decisions and adds it to the nogood store. The conflict detector will then be able to find a new family with conflicting decisions. Eventually it will no longer find any such family and the method stops.

Thus, as described herein and in a first aspect of the invention, there is provided a method for managing condition action rules comprising: building a family of cases that make some rules applicable; iteratively building and testing subsets of cases of the family for cases with conflicting decisions in order to locate a subset of cases that all have conflicting decisions.

It would be easy for rules management systems if there were only two types of sets of cases: type 1) sets where all cases have only conflicting decisions; and type 2) sets where all cases have only non-conflicting decisions. However, in reality, most sets have cases with conflicting decisions and cases with non-conflicting decisions, type 3, and must be decomposed further in order to classify them as only conflicting or non-conflicting. The above solution and that of the preferred embodiment decomposes each type 3 set into smaller subsets and iteratively repeats this decomposition until the subsets are either of type 1 or 2. Advantageously the method presented herein further comprises eliminating subsets of cases that have all non-conflicting decisions.

In one aspect of the invention the term decision is used whereas in the embodiment and other aspects of the invention the term action is used with suitable adjustments. The decision of a rule is directly linked to the action taken, for example, the decision to loan money is directly linked to the action of the loaning the money.

In one embodiment, the building task is formulated as logical satisfiability problem wherein testing for conflict is formulated as a logical unsatisfiability problem.

In one embodiment the family and subset of cases is modeled using constraint-based techniques. The present embodiment uses logical and constraint-based satisfiability techniques for checking whether two conditions of arbitrary form can simultaneously be satisfied.

The method disclosed herein is able to deal with rules making multiple decisions. Multiple decisions occur if different kinds of decisions are made for the same object (such as accepting or rejecting an insurance claim and determining the amount of damage of the insurance claim) or the same kind of decisions are made for multiple objects.

In one embodiment the method further comprises distinguishing conflicting decisions from unrelated decisions and thus avoids the reporting of false conflicts. It achieves this important filtering by performing an adequate analysis of the rule actions while taking knowledge about conflicting decisions into account. The disclosed method achieves this analysis for condition-action rules of arbitrary form as long as each rule is making entire decisions.

In one embodiment the method further comprises defining a subset of the cases with conflicting decisions such that a new rule uses the definition and eliminate the conflict. The conflicting decisions are those cases that are treated by multiple rules in different ways. It thus gives a concise report about basic forms of inconsistencies in the decision-making behavior of the ruleset. This report explains that the ruleset will not make a clear decision if it is applied to the cases listed in the report. The disclosed method produces a compact description of the cases with conflicting decisions in the form of families of similar cases. This description facilitates the task of a rule maker who seeks to establish a consistent decision-making behavior by adding rules that serve as arbitrators. For example, the rule maker may create a rule of higher priority that treats a family of cases with conflicting decisions and that imposes the desired decision. The method thus shows how to compute important information that allows a rule author to establish a consistent decision-making behavior without a tedious repair of the existing rules.

In order to find cases with conflicting decisions, in one embodiment the method uses knowledge about rule actions that are making conflicting decisions. This knowledge can be given in different form. The most explicit form is that of axioms stating that certain actions are incompatible. For example, the action of accepting a loan and the action of rejecting the same loan are incompatible. This knowledge can also be provided in form of a definition of a decision, that describes the scope of the decision, that is, the type of the object to which it is applied, and that lists the alternative actions (such as accept or reject a loan) for making this decision. The knowledge can also be given in form of properties of methods of an object model such as the property saying that a setter-method will necessarily produce different results if applied to the same object, but with different values.

However, the presently disclosed method does not require a detailed model of the rule actions (such as a model of a Java code implementing abstract method calls such as ‘accept the loan’ occurring in the rule actions) in order to determine whether these actions are making conflicting decisions. Given the knowledge about incompatible actions, it performs the consistency analysis on an abstract level.

It may happen that the knowledge about incompatible actions is incomplete. Even in this situation, the reported issues are valid. If this knowledge is extended (or refined), then the method may determine additional cases with conflicting decisions, but the previously reported issues will still remain valid under this additional knowledge.

One embodiment of the presently disclosed method leverages satisfiability techniques as elaborated in constraint programming and theorem proving to determine a family of cases that makes at least two conflicting rules applicable. The invention uses a generate-and-test approach to determine such a family of cases with conflicting decisions. The generation phase creates a family of cases that make some rule applicable, whereas the test phase checks whether each case in this family has conflicting decisions. In order to achieve this, the conflict checker tries to solve the inverse problem. It determines whether the family contains at least one case such that the actions of the rules applicable to this case do not violate any axiom about incompatible actions. If yes, certain cases in the family do not have conflicting decisions, meaning that parts of the family need to be discarded. If no, then each case of the given family makes at least two rules applicable and the actions of those rules are incompatible according to the given knowledge about rule actions. Hence, a family of cases with conflicting decisions has been detected in such a situation. Whereas the generation task is formulated as a logical satisfiability problem, the conflict check amounts to a logical unsatisfiability problem.

In one embodiment, second aspect of the invention provides a method for managing condition action rules comprising: determining compatible and incompatible action for rules in a ruleset; building a test family of cases for testing at least one rule in the ruleset; determining a compatible subset of cases of the family such that applying applicable rules in the subset results only in compatible actions; determining a test subset from the cases in the family that are not part of the compatible subset whereby one or more of the cases in the test subset has potential for conflicting actions with the rules in the ruleset; and determining the test subset is a conflicting subset if all the cases in the test subset have conflicting actions otherwise defining a new test family with the test subset and performing iterative determining of a new compatible subset and a new test subset until a new test subset is determined as conflicting.

The disclosed method helps achieve decision consistency for a rules management system, that is, it helps ensure that the same cases receive the same decisions.

This disclosed method puts the business user in overall control of a decision management platform and increases overall trust into the system.

In one embodiment the method further comprises compiling a report of the conflicting subset of cases and conflicting actions. This solution replaces a manual trial and error analysis and editing of conflicting rules.

In one embodiment each family and subset of cases is characterized by atomic conditions from the ruleset.

Suitably the method further comprises determining at least one arbitrator rule for adding to the ruleset to resolve the conflicting actions on the cases in the conflicting subset.

The determination of a family of cases with conflicting decisions permits the addition of an arbitrator rule of higher priority that enforces the desired decision.

According to a third aspect of the invention there is provided a system for managing condition action rules comprising: a treated case modeler for building a family of cases that make some rules applicable; a conflict detector for iteratively building and testing subsets of cases of the family searching for cases with conflicting decisions in order to locate a subset of cases that all have conflicting decisions.

According to a fourth aspect of the invention there is provided a conflict detector that implements generate-and-test method; and a treated case modeler that describes all cases that make some rule applicable. A rule set consequence modeler that describes which actions will be executed for which case and an action reasoner that provides knowledge about incompatible rule actions form part of the conflict detector functionality but are either physically part of or separate depending on the embodiment.

The treated-case modeler builds a ruleset applicability graph that says that some rule matches some objects in the case and that these objects satisfy the condition of the rule. The ruleset applicability graph represents a disjunction of the applicability graphs of the individual rules. The applicability graph of a rule describes the cases treated by the rule in a compact logical form.

The ruleset consequence modeler models the decision-making behavior of the ruleset in an implicit logical form by building a ruleset implication graph which describes that the actions of the applicable rules will be executed by the ruleset. Indeed, a ruleset implication graph represents the conjunction of the implication graphs of the individual rules. The implication graph of a rule describes that if the case contains objects that are matched by the rule and these objects satisfy the rule condition then the rule action will be executed by the ruleset. Given a case, a logical problem solver can then determine the applicable rules and derive the actions that will be executed. If several of these actions are incompatible, then the logical problem solver will not be able to find a solution of the ruleset implication graph for the given case. It has thus shown that this case has conflicting decisions.

The action reasoner manages the knowledge about conflicting actions. It uses this knowledge to generate incompatibility constraints between the rule actions that occur in the ruleset. If a rule is making multiple decisions by executing a sequence of actions, the action reasoner handles assignments and derives the values of intermediate expressions modified due to these assignments. Furthermore, it achieves a comparison of different action sequences by adequate transformations (that is, by bringing the actions of different sequences into the same order).

The conflict detector searches a family of cases that make conflicting decisions by pursuing the generate-and-test method described above. It thus consists of a case-family generator and a conflict-checker. The case-family generator searches through the space of treated cases, that is, the cases that make at least one rule applicable. The case-family generator uses a nogood store in order to eliminate previously generated candidates that have either been discarded by the conflict checker or already been included in the report about cases with conflicting decisions. Initially, this nogood store is empty. In order to find a new family of treated cases, the case-family generator submits the ruleset applicability graph and the nogoods to a treated-case solver. If the treated-case solver does not find a labeling of the ruleset applicability graph and the nogoods that marks the root nodes with true and that respects all graph operations, then there is no applicable rule and the whole analysis stops. Otherwise, the case-family generator extracts a family of treated cases from the graph labeling by inspecting the truth values of the propositional nodes in the graph. It then sends this family of cases to the conflict checker.

The conflict checker constructs a non-conflict graph which represents the conjunction of the family of treated cases, the ruleset-implication graph, and constraints about incompatible actions occurring in the ruleset-implication graph. The conflict checker requests these constraints from the action reasoner. The conflict checker submits the non-conflict graph to a non-conflict-graph solver. If the non-conflict-graph solver finds a labeling that satisfies the graph, then the candidate case family contains at least one case that does not have conflicting decisions. The conflict checker seeks to eliminate this case as well as similar cases. It therefore constructs a refined family of cases by inspecting the labeling produced by the non-conflict-graph solver. The cases in the refined family satisfy a propositional node in the non-conflict graph if and only if this node has been labeled true. The conflict checker thus uses these propositional nodes and their label to produce a description of the refined family. It then sends this refined family to the case-family generator which transforms it into a nogood and thus eliminates the cases in the refined family. The generator will then produce a new family of treated cases and the method is iterated. However, if the non-conflict-graph solver does not find a labeling satisfying the non-conflict graph, then the non-conflict graph has no solution, meaning that the given case family has conflicting decisions. The conflict checker then includes this case family in the final report.

In a particular embodiment, the conflict checker generalizes the refined family by using consistency-based explanation methods before sending it to the case-family generator.

The method is iterated in order to find further families of cases with conflicting decisions. For this purpose, the conflict checker informs the case-family generator that it has included a case with conflicting decisions in the report. The case-family generator then adds a nogood to its nogood store that avoids a regeneration of this family. Then it seeks to generate a new family and submit it to the conflict checker. The method stops when the case-family generator finds no further family.

According to a fifth aspect of the invention there is provided a computer program product comprising computer readable recording medium having computer readable code stored thereon for detecting cases with conflicting rules, said computer readable code which when loaded onto a computer system and executed performs the following steps: building a family of cases that make some rules applicable; iteratively building and testing subsets of cases of the family searching for cases with conflicting decisions in order to locate a subset of cases that all have conflicting decisions.

According to a sixth aspect of the invention there is provided a computer program stored on a computer readable medium and loadable into the internal memory of a digital computer, comprising software code portions, when said program is run on a computer, for performing the method disclosed herein.

Further embodiments of the invention are now described.

It will be clear to one of ordinary skill in the art that all or part of the method of the preferred embodiment may suitably and usefully be embodied in additional logic apparatus or additional logic apparatuses, comprising logic elements arranged to perform the steps of the method and that such logic elements may comprise additional hardware components, firmware components or a combination thereof.

It will be equally clear to one of skill in the art that some or all of the functional components of the preferred embodiment may suitably be embodied in alternative logic apparatus or apparatuses comprising logic elements to perform equivalent functionality using equivalent method steps, and that such logic elements may comprise components such as logic gates in, for example a programmable logic array or application-specific integrated circuit. Such logic elements may further be embodied in enabling elements for temporarily or permanently establishing logic structures in such an array or circuit using, for example, a virtual hardware descriptor language, which may be stored and transmitted using fixed or transmittable carrier media.

Note that in one or more embodiments, the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be clear to one skilled in the art that many improvements and modifications can be made to the foregoing exemplary embodiment without departing from the scope of the present invention.

1. A method for managing condition action rules in a ruleset comprising:
building a family of cases that make some rules in the ruleset applicable;
iteratively building and testing subsets of cases of the family for cases with conflicting decisions in order to locate a subset of cases that all have conflicting decisions.

2. A method according to claim 1 further comprising eliminating subsets of cases that have all non-conflicting decisions.

3. A method according to claim 1 or 2 wherein the family and subset of cases is modeled using constraint-based techniques.

4. A method according to any of claims 1 to 3 further comprising distinguishing conflicting decisions from unrelated decisions and thus avoids the reporting of false conflicts.

5. A method according to anyone of claims 1 to 4 further comprising defining a subset of the cases with conflicting decisions such that a new rule uses the definition and eliminate the conflict.

6. A method for managing condition action rules comprising:
determining compatible and incompatible actions for rules in a ruleset;
building a test family of cases for testing at least one rule in the ruleset;
determining a compatible subset of cases of the family such that applying applicable rules in the subset results only in compatible actions;
determining a test subset from the cases in family that are not in the compatible subset whereby one or more of the cases in the test subset has potential for conflicting actions with the rules in the ruleset; and
determining the test subset is a conflicting subset if all the cases in the test subset have conflicting actions otherwise defining a new test family with the test subset and performing iterative determining of a new compatible subset and a new test subset until a new test subset is determined as conflicting.

7. A method according to claim 6 wherein the family and subset of cases is built using a constraint model of the rules in the ruleset.

8. A method according to claim 6 further comprising compiling a report of the conflicting subset of cases and conflicting actions.

9. A method according to any of claims 6 to 8 wherein each family and subset is characterized by atomic conditions from the ruleset.

10. A method according to claim 6 further comprising determining at least one arbitrator rule for adding to the ruleset to resolve the conflicting actions on the cases in the conflicting subset.

11. A system for managing condition action rules comprising:
a treated case modeler for building a family of cases that make some rules applicable;
a conflict detector for iteratively building and testing subsets of cases of the family for cases with conflicting decisions in order to locate a subset of cases that all have conflicting decisions.

12. A system according to claim 11 wherein the conflict detector is further adapted for eliminating subsets of cases that have all non-conflicting decisions.

13. A system according to any of claims 11 to 13 wherein the conflict detector is further adapted for distinguishing conflicting decisions from unrelated decisions and thus avoids the reporting of false conflicts.

14. A computer program product comprising computer readable recording medium having computer readable code stored thereon for detecting cases with conflicting rules, said computer readable code which when loaded onto a computer system and executed performs the following steps: building a family of cases that make some rules applicable; iteratively building and testing subsets of cases of the family searching for cases with conflicting decisions in order to locate a subset of cases that all have conflicting decisions.

15. A computer program stored on a computer readable medium and loadable into the internal memory of a digital computer, comprising software code portions, when said program is run on a computer, for performing the method of any of claims 1 to 4.
